(19) United States
(12) Patent Application Publication
(10) Pub. No.: US 2022/0222294 A1
(43) Pub. Date: Jul. 14, 2022

(54) Densification in Music Search and Recommendation

(71) Applicant: Smule, Inc., San Francisco, CA (US)

(72) Inventors: Cheng-i WANG, San Francisco, CA (US); Stefan SULLIVAN, San Francisco, CA (US); David Adam STEINWEDEL, San Francisco, CA (US); George TZANETAKIS, Victoria (CA)

(21) Appl. No.: 17/181,791

(22) Filed: Feb. 22, 2021

(30) Foreign Application Priority Data
Jan. 14, 2021 (GR) 20210100031

(51) Int. Cl. G06F 16/632; G06N 20/00; G06F 16/683; G06F 16/65; G06F 16/61

(52) U.S. Cl. CPC G06F 16/634; G06N 20/00; G06F 16/61; G06F 16/65; G06F 16/685

(57) ABSTRACT

Disclosed herein are computer-implemented method, system, and computer-readable storage-medium embodiments for implementing densification in music search. An embodiment includes processor(s) configured to obtain a first feature set extracted from a first audio recording, and a first fingerprint of the first audio recording; and evaluate, using at least one first machine-learning algorithm, a similarity index corresponding to the first audio recording with respect to at least one second audio recording, considering: the first feature set extracted from the first audio recording, and a second feature set extracted from the at least one second audio recording; or the first fingerprint of the first audio recording, and at least one second fingerprint of the at least one second audio recording. Further embodiments include defining arrangement group(s) including the first audio recording and the at least one second audio recording with similarity index within a predetermined range, outputting densified response(s) to a search query.

### BACKGROUND

### Field

This disclosure is generally directed to deduplication or densification of results in music search and information retrieval.

### Background

The installed base of mobile phones, personal media players, and portable computing devices, together with media-streaming devices and television set-top boxes, continues to grow in number and computational power. Ubiquitous and deeply entrenched in the lifestyles of people around the world, many of these devices transcend cultural and economic barriers. Computationally, each generation of these computing devices offer speed and storage capabilities comparable to engineering workstation or workgroup computers from less than ten years prior, and typically include processors suitable for real-time sound synthesis, audiovisual processing, and other multimedia applications. Indeed, some modern devices, including handheld and other embedded devices, support audio and video processing quite capably, while at the same time providing platforms suitable for advanced user interfaces.

Using such devices, existing applications have shown that digital acoustic techniques may be delivered in ways that provide compelling musical experiences. However, user experience with such applications can be affected not only by the sophistication of digital acoustic techniques implemented, but also by the breadth, variety and quality of content available to support their advanced features. Musical scores, backing tracks, and lyrics are important components of that content, but information concerning these components are usually labor-intensive to generate and timely publish, particularly when considering the large numbers of new musical performances that may be released and popularized each week for certain musical genres, such as pop music.

Ever-growing user bases demand increased breadth, variety, and timely incorporation of high-quality musical content into a library made available in a social music network or content repository. Accordingly, there is ever-increasing demand for computational systems and techniques that may empower large networks of users to create and refine at least some musical content that the advanced digital acoustic applications rely upon.

A similar driver of demand is a desire to facilitate the generation of community-sourced or crowd-sourced musical score content, which may also leverage related techniques. Enabling users to create and/or upload digital content, presents extra difficulties of retrieving, organizing, and otherwise curating the materials involved with third-party content, such as user-generated or crowd-sourced content. A conventional search engine can be swamped by growing quantities of catalog entries numbering in millions and beyond. Many of these entries tend to be closely related if not duplicated, as users tend to upload the most popular songs for their region, language, and preferred genre(s). Thus, enhanced techniques for deduplication or densification of search results are needed for such modern platforms that foster creation and consumption of audio, video, and/or multimedia content.

### SUMMARY

Music Information Retrieval (MIR) techniques may be employed and automated to discover duplicate (or near-duplicate) materials and content instances, cluster such materials, and determine one or more “canonical” versions of each arrangement or other instance. Machine curation and “densification” (deduplication and/or clustering) of a large corpus of user-uploaded materials is thereby made possible, reducing, potentially by orders of magnitude, what would otherwise be an unmanageable flood of search results, while delivering the most relevant catalog entries and a diverse selection of other related hits. Search and recommendation techniques applied to a densified catalog may thus improve overall user experience on a given platform for various media creation and consumption.

Provided herein are system, apparatus, article of manufacture, method and/or computer program product embodiments, and/or combinations and sub-combinations thereof, for using technology in innovative ways to provide enhanced functionality for media streaming, virtual karaoke, remote choir, and other social music experiences. An embodiment is directed to system, apparatus, article of manufacture, method and/or computer program product embodiments, and/or combinations and sub-combinations thereof, for densification in music search, to filter similar entries and derive a variety of meaningful results, improving efficiency and quality of information retrieval.

In some non-limiting embodiments, the apparatus may be a general-purpose computing device or a more dedicated device for various media consumption and/or production, and the content may be an audio recording or a music video, naming just a few examples. The apparatus may include a memory and/or a non-transitory computer-readable storage device, having instructions stored therein. When executed by at least one computer processor, various operations may be performed, locally or remotely, in response to a query from a user. With the implementation of the enhanced techniques disclosed herein, densified search results may be provided for MIR. In this way, the user may find more compositions of interest and fewer duplicates or undesired variations. Similarly, working from a densified catalog, a music recommendation engine can better accomplish the goal of suggesting content to users that is more in their interest, thus encouraging increased engagement and, providing a richer user experience.

Another embodiment is directed to system, apparatus, article of manufacture, method and/or computer-program product (non-transitory computer-readable storage medium or storage device) embodiments, and/or combinations and sub-combinations thereof, for signal processing, to facilitate feature extraction, fingerprinting, and other functions that may be useful in processes of densification in music search for MIR.

An embodiment may include at least one computer processor configured to obtain a first feature set extracted from a first audio recording, and a first fingerprint of the first audio recording, and to evaluate using at least one first machine-learning algorithm, a similarity index corresponding to the first audio recording with respect to at least one second audio recording, based at least in part on the first feature set extracted from the first audio recording, and a second feature set extracted from the at least one second audio recording; considering the first fingerprint of the first audio recording, and at least one second fingerprint of the at least one second audio recording; or a combination thereof. Further embodiments may also include defining one or more arrangement groups including the first audio recording and the at least one second audio recording having a corresponding similarity index within a predetermined range, outputting one or more densified responses to a search query.

Additionally, some embodiments may further include analyzing a frequency spectrum of the audio recording for each of a plurality of time values of at least part of a time duration of the first audio recording; calculating at least one local extreme value in a frequency domain for each of the plurality of time values of the at least part of the time duration of the first audio recording; selecting, for each of the plurality of time values, a first frequency value corresponding to a first local extreme value. Further embodiments may also include populating, for the at least part of the time duration of the first audio recording, a first tuple comprising the first frequency value for each of the plurality of time values; and computing a first hash value of the first tuple.

Some embodiments may further include selecting, for each of the plurality of time values, a subsequent frequency value corresponding to a subsequent local extreme value; populating, for the at least part of the time duration of the first audio recording, a subsequent tuple comprising the subsequent frequency value for each of the plurality of time values; and computing a subsequent hash value of the subsequent tuple. The first fingerprint may generated based at least in part on the first hash value and at least one instance of the subsequent hash value, for example.

Additional embodiments may further include identifying, by the at least one computer processor, the first audio recording based at least in part on the first fingerprint; and referencing, by the at least one computer processor, a data store corresponding to the first audio recording. Moreover, the obtaining may include retrieving, by the at least one computer processor, the first feature set from the data store corresponding to the first audio recording, wherein the first feature set has been previously extracted from the first audio recording and stored in the data store corresponding to the first audio recording.

In some further embodiments the first feature set may be based at least in part on frequency-spectral peaks in a time domain of the first audio recording. Additionally, or alternatively, a search result may include a canonical arrangement representing the first arrangement group. Moreover, further embodiments may include assigning a priority value to the canonical arrangement relative to other audio recordings that correspond to non-canonical arrangements.

Further, determining that the similarity index is within the predetermined range may indicate, within a predetermined confidence interval, that the first audio recording and the at least one second audio recording were created using a same backing track or using different backing tracks having a predetermined degree of similarity. Some further embodiments may further include detecting, using at least one second machine-learning algorithm, the first fingerprint, or a combination thereof, a first set of lyrics corresponding to the first audio recording; detecting, using the at least one second machine-learning algorithm, the at least one second fingerprint, or a combination thereof, at least one second set of lyrics corresponding to the at least one second audio recording; and defining at least one second arrangement group corresponding to the at least one second set of lyrics.

Moreover, further embodiments may include redefining the first arrangement group to exclude audio recordings corresponding to lyrics different from the first set of lyrics. The first set of lyrics may correspond to a first language, and the at least one second set of lyrics corresponds to at least one second language, for example. The first language may correspond to the first arrangement group, and a given second language of the at least one second language may correspond to a second arrangement group, according to some embodiments.

It is to be appreciated that the Detailed Description section below, not the Summary or Abstract sections, is intended to be used to interpret the claims. The Summary and Abstract sections may set forth some, but not all, possible example embodiments of the enhanced densification techniques described herein for music search and recommendation, and therefore are not intended to limit the appended claims in any way.

### BRIEF DESCRIPTION OF THE DRAWINGS

The accompanying drawings are incorporated herein and form a part of the specification.

FIG. 1 is a treemap illustrating multiple genres and their respective shares representing multiple arrangement groups of one song, according to some embodiments.

FIG. 2 illustrates an example process flow in relation to at least one example system, according to some embodiments.

FIG. 3 illustrates a flowchart for an example method of generating audio fingerprints, according to some embodiments.

FIG. 4 illustrates a plot of example parameters ordered by metrics as applied with an example audio fingerprinting algorithm, according to some embodiments.

FIG. 5 illustrates a similarity histogram and receiver operating characteristic (ROC) curve corresponding to an example composition, according to some embodiments.

FIG. 6 illustrates a similarity histogram and ROC curve corresponding to an example arrangement group, according to some embodiments.

FIG. 7 illustrates a similarity histogram and ROC curve corresponding to an example composition having an alternative parameter set, according to some embodiments.

FIG. 8 illustrates a similarity histogram and ROC curve corresponding to an example arrangement group having the alternative parameter set, according to some embodiments.

FIG. 9 illustrates an example audio waveform, according to some embodiments.

FIG. 10 illustrates an example audio spectrogram corresponding to the waveform of FIG. 9, according to some embodiments.

FIG. 11 illustrates the spectrogram of FIG. 10, smoothed using an example filter, according to some embodiments.

FIG. 12 illustrates the smoothed spectrogram of FIG. 11, highlighting examples of designated landmarks, according to some embodiments.

FIG. 13 illustrates example values as related in data structures corresponding to tuples using an example audio fingerprint derivation, according to some embodiments.

FIG. 14 shows a histogram of lyrics length in number of words, according to some embodiments.

FIG. 15 shows a histogram of normalized lyrics length by arrangement groups, according to some embodiments.

FIG. 16 illustrates a flowchart of an example method of densification in music search, according to some embodiments.

FIG. 17 illustrates a block diagram of a multimedia environment that includes one or more media systems and one or more content servers, according to some embodiments.

FIG. 18 illustrates a block diagram of a media device, according to some embodiments.

FIG. 19 illustrates an example computer system useful for implementing various embodiments.

In the drawings, like reference numbers generally indicate identical or similar elements. Additionally, generally, the leftmost digit(s) of a reference number identifies the drawing in which the reference number first appears.

### DETAILED DESCRIPTION

### Definitions

Arrangement—A version of a song or composition. In some example use cases, an arrangement may be crowd-sourced or created by third-party contributors who may submit custom arrangements to an online community via various means. Additional examples of arrangements may include compositions or songs available by commercial licensing, creative commons, or available in the public domain. Arrangements may include backing tracks, vocals, timing information, and/or other metadata to guide playback, for example. Arrangements may be used to create performances on an online platform, in some embodiments. An arrangement may be considered to be an implementation of a particular song and may include information and resources needed for users (e.g., of a given platform) to create performances from the arrangement. An arrangement may include a backing audio track and a title, and possibly lyrics, artist information, genre (metainformation or metadata), etc., corresponding to the song. For example, a composition or song with a title “Amazing Grace, Elvis version” and having a backing audio track may be referred to as an arrangement.

Composition—A core component of an arrangement, which may represent a musical creation. “Take On Me” may be referred to as a composition. Many arrangements may be based on a composition. A composition may also be referred to as a piece or a song, and these terms may be used interchangeably throughout this disclosure. For example, “Amazing Grace” may be referred to as a song, a piece, or a composition.

Unidentified Composition—Not all arrangements in a given collection of arrangements are linked to an identified composition. An unidentified composition may be considered to be a placeholder to hold arrangements that may be likely to be based on the same composition.

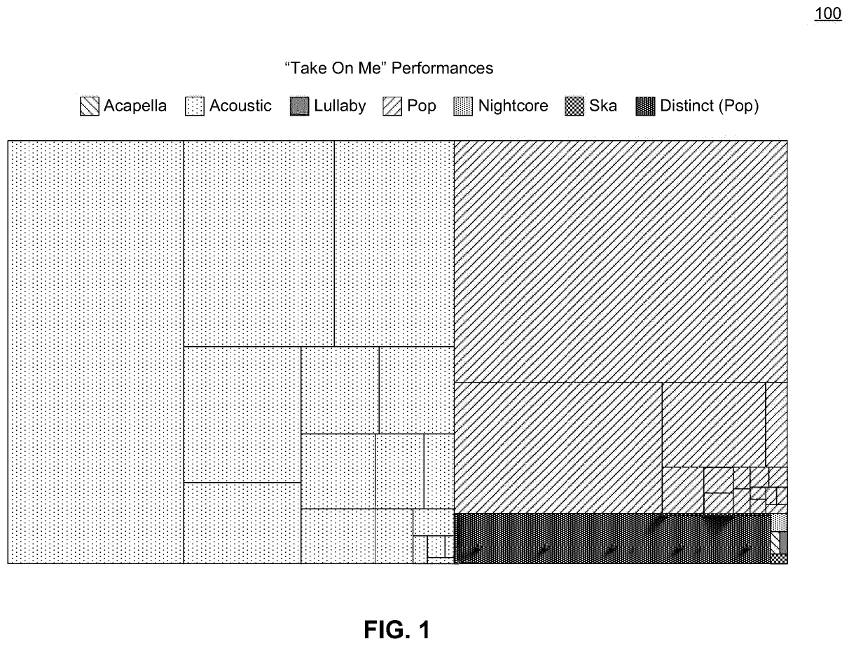

Genre—A classification category in which an arrangement can be placed, typically based on content of a specific arrangement. A given composition or song may span multiple genres or be reworked into different genres, as shown in FIG. 1, for example.

FIG. 1 is a treemap 100, for illustrative purposes of this example, that shows multiple genres and their respective shares, of each genre and of all “Take On Me” arrangements in a given content library. Thus, treemap 100 is a visual representation of multiple arrangement groups, showing multiple arrangements (spanning multiple genres) of a selected composition (in this case, the song “Take On Me”), according to some embodiments. The “distinct” category, in an embodiment, may represent various arrangements of the “pop” genre that have been confirmed not to have duplicate arrangements in a given content library, for example.

Arrangement Grouping—A level that may exist between composition and arrangement that defines a set of arrangements that are similar enough to be considered copies of each other, for purposes of music search or information retrieval. An arrangement group may include arrangements having the same or similar audio backing track, lyrics, or a combination thereof. For example, if two arrangements have the same genre (irrespective of how the given genre may be determined) but different backing tracks, they may be assigned to different arrangement groups.

In some embodiments, arrangement groupings may be defined such that, if two arrangements use the same backing track, they should be duplicates of each other, thus belonging to the same arrangement group. A special case may arise when arrangements using the same backing track have different versions of lyrics (e.g., original lyrics, radio version, different languages, etc.). In this case, the different arrangements may be defined as belonging to different respective arrangement groups. An arrangement group, for example, may have multiple arrangements all using the same/similar backing track of a particular version of Amazing Grace and using the same lyrics.

Arrangement Properties—These are properties that may be assigned to an individual arrangement and may be used to define arrangement groups thereby.

Origin—Sometimes a Composition will be labeled by users based on origin, such as where the version gained popularity. For example, the acoustic version of “Take On Me” is often referred to as the “Deadpool version” since it was made famous by the Deadpool film.

Language—For purposes of this disclosure, “language” may refer to a language, dialect, or register represented by lyrics of a particular song/arrangement, where applicable.

Backing Track—The audio track or file that may be used as the instrumental background music and/or vocal accompaniment such as for karaoke performances. Thus, for an arrangement entitled “Amazing Grace, Elvis version,” the underlying audio file or track used in creating the song may be referred to as a backing track. In some use cases, backing tracks may be one or more instrumental tracks that may be separate from any vocals of the song. In other use cases (e.g., other songs or backing tracks of the same song), one or more pre-recorded vocal tracks of the song may be included as part of the backing track, for example, as a guide for melody, harmony, or other accompaniment.

Backing Track Source (BTS)—BTS may refer to a source of a backing track. A BTS may help to determine whether the backing track is in common (e.g., as a duplicate track) with that of other arrangements.

Key—A key may generally refer to a scale of musical notes or pitches, such as a musical key of B-flat major or G minor, to name a few non-limiting examples.

Vocal range—A vocal range, including for songs that may allow for karaoke, sing-along, virtual choir or remote choir functionality, may be used for identifying vocal pitch of a singer, without (or before) any adjustment. Common labels from users may be “higher,” “lower,” “male,” “female,” “soprano,” “baritone,” etc.

Canonical Arrangement—A primary arrangement for a single arrangement group. A canonical arrangement may be an official release from an artist, or otherwise based on a production that is well known compared with other arrangements in the same arrangement group. In some embodiments of the present disclosure, a canonical arrangement may be determined automatically by using enhanced techniques described elsewhere herein, such as by a machine-learning process, an algorithm, or any combination thereof.

Canonical Group—A primary arrangement group for a composition.

Context

In one example data set (e.g., arrangement catalog or music library), it may be determined that approximately 14 of every 100 arrangements are unique across the data set. If we take the definition of canonical above and apply it to the current example data set, ˜7% of canonical arrangements may cover ˜80% of the arrangements therein, for example, which is indicative of a relatively large amount of overlap or duplication, even within a relatively small corpus of compositions. One example use case is a popular song, “Take On Me,” specifically applied as the subject of an arrangement-tied template for user-generated content Examples of templates for some embodiments are found in commonly owned U.S. Pat. No. 10,726,874, the entirety of which is incorporated by reference herein for all purposes.

In this use case, during the first three weeks of a given month, for example, this particular composition was performed over 1700 times, at the core of 38 related arrangements. However, diversifying search results by funneling users into fewer arrangements per composition (reducing duplicative results), such an approach may increase social connections and lead to more platform engagement at least in the form of user-generated content (e.g., performances shared or uploaded) and more social interactions.

Goals

A goal for a platform, and an expected desire of a user, is that when the user is looking for a song, the user expects to find that song. As a corollary, when the user wants a specific version of a song, the user should be easily able to find the desired version. Presenting diversified results or recommendations may also be useful to this end, increasing the likelihood of a song of interest being retrieved, rather than filling a result set with duplicates that may be unwanted or irrelevant.

Users are funneled to the correct arrangement based on what they are looking for. When multiple users are looking for the same thing, they may be funneled to the same arrangement accordingly.

To realize these goals, a platform may leverage various available resources to solve the problems in the way of achieving these goals. MIR may leverage techniques such as fingerprinting and/or other machine-learning processes to aid detection of content instances that may have the same or similar backing track, for example.

Regarding machine-learning (ML), various algorithms and related processes may be used to facilitate evaluation, classification, identification, and/or detection of certain components, such as musical backing tracks, of a given content instance or grouping thereof (e.g., defining an arrangement group). For example, machine-based classification, clustering, and/or ML algorithms may include, but are not limited to, fuzzy matching (approximate string matching) and its extensions to non-string domains such as audio, tokens, fingerprints, graph-based clustering and tree-based clustering or extensions thereof for grouping/deduplicating, etc. Additionally with these algorithms, or alternatively, MinHash algorithms may be used, such as for similarity estimations.

A platform or its owner or administrator may create and/or maintain a library or repository and organizational structure of compositions, arrangement groupings, other arrangement data, or a combination thereof. The library or repository may include known and unknown compositions, such that arrangements may be matched to each other without needing the composition to be known in advance. This configuration and capability may allow the platform to present canonical arrangements and/or canonical-version arrangements to users in a logical way that facilitates retrieval by users, improving user experience.

The platform, library, or repository may share metadata among duplicate arrangements based on the canonical-version arrangement. Similarly, in some embodiments the platform may allow easy editing of data to manually patch, edit, cleanup, and provide feedback to algorithmic errors. As a result of any of these enhancements, search techniques may be made sophisticated enough such that other elements of a user interface (UI) or user-experience (UX) design and functionality may not need any particular adjustments to facilitate MIR by users beyond what is offered by the platform applying the techniques disclosed herein.

Quality of deduplication algorithms may have the most direct effect on user experience. Deduplicating incorrectly may hide arrangements/songs/compositions that a user may specifically seek. Another potentially complicating factor involves songs that may have versions famous in multiple genres (e.g., “Hurt” by Nine Inch Nails originally, covered by Johnny Cash), which may have famous items relegated to second-order arrangements within a certain arrangement groups, in some embodiments. However, specific exceptions may be made, in some cases, within a given library or repository, within a given algorithm, or a combination thereof.

Piece: Composition-Level Object

An object may be configured to occupy a conceptual space that is the same as or similar to a song, a music piece, a music composition, etc. This object may be leveraged to perform the function of grouping arrangements together into effectively the same song or equivalent thereof. This object may be referred to as a piece, a song, or a composition, as noted with the definitions listed herein above.

The grouping of arrangements under a piece maybe set to match 1:1 with how arrangements match under a composition. These data sets may mirror each other, in some embodiments, with an exception that a “piece” data set may include all corresponding arrangements, whereas a “composition” data set may be filtered, narrowed, or otherwise reduced to identified compositions, for example.

Constraints

When new arrangements are uploaded, each one may be filed with an appropriate piece ID, for example, at upload time. As a result, when identifying a new arrangement group, evaluating it, and determining how it may match to an existing piece, arrangements or arrangement groups may be linked together seamlessly and without ambiguities.

Arrangement Groupings

Arrangement Groups may be defined by characteristics including matching backing tracks and matching lyrics. An arrangement group may be defined at a level between pieces and individual arrangements. An arrangement group may represent how a user thinks about a particular song. Some examples of how a user may think about a particular song are provided in Table 1 below:

TABLE 1

| “Let It Go” | “Take On Me” | “Hallelujah” |
|---|---|---|
| “It's from the movie | “It's just ‘Take On | “I don't know; it's just |
| Frozen” | Me’ -what do you | that Hallelujah song” |
| | mean, ‘versions'?” | |
| “There was a | “The guitar version | “The one by Leonard |
| different version | from Deadpool | Cohen” |
| that played during | where he sang | |
| the movie credits” | karaoke” | |
| “The version from | | “The one by Jeff Buckley” |
| Frozen on Ice” | | |
| “That acoustic version | | “The one by Alexandra |
| I heard one time” | | Burke” |
| “The metal version” | | “The one by the lady on |
| | | Saturday Night Live” |

The definition for arrangement groupings may be considered loose in manner, although definitions may be made stricter or looser as needed, adjusting for various preferences, data sets, or other factors. Reasons for loose definitions may include efficacy of consolidation. For example, as arrangement groups are made tighter, there may be less total consolidation (more groups overall). Another reason for loose definitions may be that, because music is not all purely logical or hierarchical, some features may be applicable in some cases but not in other cases.

Using a BTS in combination with lyrics may achieve groupings in ways that may apply more closely to user intent. BTS and lyrics may both be assessed empirically and detected algorithmically, may both provide groupings that make sense to users in many cases, and may more effectively avoid content-creators gaming the system for trending content or recommendations.

Canonical Arrangements and Grouping

To serve the goals of getting users to the song they want quickly and funneling them into the same arrangement, canonicalization at the arrangement-grouping level may further facilitate these goals. Thus, for a given arrangement group, a single arrangement (version) may be selected to act as the canonical arrangement or canonical version.

If a first-party arrangement exists, for example, originating from a trusted source such as a music publisher, partner artist (e.g., a contractor who produces or licenses content for use on a given platform), management group, or in-house music production team, such arrangements may be prioritized, for some use cases. Otherwise, for third-party arrangements, ML-based and/or algorithmic solutions may be employed, as an alternative to a “first in, always on top” system. Because non-canonical arrangements may still be accessed through other means (direct sharing, profiles, etc.) it is possible that higher quality versions may gain enough signal to be considered to be a canonical arrangement. Absent meaningful input data here from the non-canonical or third-party sources, then a default priority rule may rank first-party arrangements first (including those of partner artists) first, and/or rank remaining arrangements based on a confidence interval, normal approximation interval, Wilson score, or equivalent, which may be computed based at least in part on upvotes, downvotes, “likes,” listens (playbacks), user performances, or any combination thereof, for example.

Search

Through the process of searching for content (e.g., music search or similar information retrieval), the results of the above-described clustering, consolidation, or densification may thus be presented to the user, in an intuitive and logical manner. Relevance of returned search results may be increased by considering duplicate results as less relevant. A user may thus perceive the results as more accurate or diversified, if not also more precise, while still allowing discovery of new and different pieces, arrangements, versions, etc.

In some embodiments, returning a canonical arrangement of a given arrangement grouping may have an improved likelihood of yielding a user's desired result. A way of doing this, for example, may include systematically boosting or promoting a canonical arrangement among a set of search results, for example.

Manual Data Cleanup

Densification may improve search and search results in that a library or repository containing millions of unique arrangements may be condensed into a more manageable (smaller) set of arrangement groups, which may serve as proxies for arrangements. In some example test cases, libraries or repositories of tens of millions of unique arrangements including user-generated content may be densified into tens of thousands of unique arrangement groups.

Because of efficiencies yielded by this densification and reduction of search space, manual curation of this content and related data may become more manageable. Therefore, when filtering down arrangement groups that rank highly by popularity for a given library or repository, it becomes possible to curate a larger percentage of frequently-accessed content manually with considerably less effort on the part of a platform or end-user.

Accordingly, it is desirable to have options to curate content, clean up data, and customize various settings by hand. Table 2 below lists a few options that may be tweaked, tuned, or otherwise configured or customized, either by an intermediate user (e.g., owner, administrator, etc.) of a platform, end-users of the platform, or both.

TABLE 2

| Level | Item | Notes |
|---|---|---|
| Composition | Canonical | Whatever is set manually here may revert, |
| | Arrangement | over time, to algorithmic grouping auto- |
| | Grouping | matically. One use case is to artificially |
| | | elevate an arrangement group for a promo- |
| | | tion campaign or other event. |
| Arrangement | Canonical | This option may be tuned on a semi- |
| Group | Arrangement | permanent basis, unless an arranger makes |
| | | updates to lyrics, parts/segments, timing, |
| | | etc., at which point an algorithm may take |
| | | over for automatic grouping and/or |
| | | canonicalization. |
| Arrangement | Consolidation | When two arrangement groups are found |
| Grouping | Tagging or | that should be the same, this option |
| | Topic Setting | presents a quick way to consolidate them. |
| | | Such information (e.g., added tags or |
| | | topics) may also be fed back into the |
| | | MIR algorithm, in some embodiments. |
| Arrangement | Move to | When an arrangement is found in an |
| | Group | incorrect group (and the correct group |
| | | is known by the user), the arrangement |
| | | may be moved to the defined group and |
| | | fed back to a MIR algorithm. |
| Arrangement | Create Group | When an arrangement is found in an |
| | | incorrect group, and no existing groups |
| | | are correct, a new arrangement group |
| | | may be created. This new group may be |
| | | fed back to the MIR algorithm. |

Duplication

Duplication may exist in a library or repository, at different levels or senses of the term “duplication” as used in this disclosure. In an embodiment, duplication at a level of a composition or piece may concern whether two specific arrangements embody the same composition or song, for example.

At another level, there may be other aspects to determining duplication at the level of arrangements (e.g., are two arrangements the same?). Arrangement-level duplication may consider any one or any combination of the following:

a. Different instrumentations, e.g., acoustic guitar version versus piano version versus MIDI remake version, etc.

b. Same instrumentation, but may differ in terms of beginning and trailing silences, notes, keys, timbre, different levels of sound quality, volume, compression, etc.

c. Same audio file or waveform for an arrangement or backing track, but may still differ in terms of beginning and trailing silences, different compression algorithms, etc.

Thus, at the arrangement level, any of a, b, c, or any combination thereof, as listed above, may be considered when defining arrangement groups with respect to arrangements, and/or when assigning arrangements to a given arrangement group.

Densification

Arrangement densification may include processes for deduplication and/or clustering, according to some embodiments. Deduplication may identify or find matching arrangement groups for a given set of arrangements. Clustering may separate a given set of arrangements into subgroups such that the arrangements within subgroups are duplicates of each other while arrangements between subgroups form different arrangement groups. For purposes of this disclosure, either or both of these processes, alone or in combination, may be referred to as densification, or densifying, of a content collection (library or repository), for example.

Arrangement Group

Table 3 below shows criteria for whether any two arrangements may be defined as belonging to a common arrangement group (“same”) or to different arrangement groups (“different”). Table 3 shows an example of logical mapping of operational definitions of arrangement groups in terms of backing track, genre, origin, language, key, length, and vocals, according to a non-limiting embodiment.

TABLE 3

| Two arrangements have | same backing track | different backing track |
|---|---|---|
| same genre | same | different |
| different genre | N/A | different |
| same origin | same | N/A |
| different origin | N/A | different |
| same language | same | different |
| different language | different | different |
| same key | same | different |
| different key | N/A | different |
| same length | same | different |
| different length | same | different |
| same vocals | same | different |
| different vocals | N/A | different |

For example if two arrangements have the same genre in common (irrespective of how genre is determined) but a different backing track, the two arrangements may be assigned accordingly to different arrangement groups. It may follow that, if the two arrangements use the same backing track, they may be treated as duplicates of each other, thus belonging to the same arrangement group. A special case may be when two arrangements use the same backing track but are attached with lyrics in different languages. In this case, the two arrangements may be considered as belonging to two different arrangement groups.

Audio Fingerprinting Algorithm

For audio fingerprinting, according to some embodiments, related processes or algorithms may have any combination of the following properties:
Accuracy—relatively high precision and recall rate.
Reliability—relatively high precision reducing false positives.
Robustness—relatively consistent functioning irrespective of volume, compression, minor distortion, beginning/ending differences in the backing track audio, etc.
Scalability—ability to perform consistently even with millions of arrangements.
Complexity—reasonable computation overhead and costs for audio feature extraction, densification, and database operations, for example.

Search

For results returned when users use a search function, e.g., in an app: Searching an artist name, Britney Spears, Whitney Houston, etc., reducing duplicate arrangements, such that the same song may still appear multiple times on the top of the list if the multiple search hits have different backing tracks. As a result, the content shown to users may have more diversity than without arrangement groups. Searching a song title, different versions of the song may be returned on or near the top of the list, before duplicates are shown.

Arrangement Canonicalization/Clustering Algorithms for ML

Titles, lyrics, or other features of content instances may be processed with hashing, for example, locality-sensitive hashing (LSH) for a given edit distance, MinHash, Order MinHash, or any combination thereof, according to some embodiments. Additionally, or alternatively, one or more affinity score of elastic search indices corresponding to lyrics may be generated, derived, or retrieved, for specific content instances.

Such processes or steps thereof may be used for improving ML algorithms. For example, any result(s) of a given statistical analysis may be fed back to a given ML process as features in a given feature set as otherwise extracted or retrieved, in some embodiments.

Deduplication and Clustering

Arrangement densification can be divided into tasks sharing core technologies including deduplication and clustering, according to some embodiments. Related technologies may include audio fingerprinting, arrangement-densification algorithms (clustering and/or deduplication) based on audio fingerprinting, canonical-arrangement selection, and any combination thereof. A piece-level schema (for the term “piece” as defined and described herein) may be used in addition to or instead of an arrangement-group-level schema as concepts to facilitate efficiently storing arrangement group information out of the densification processes and establish relationships from arrangement groups to other entities (arrangements, performances, users, etc.).

Deduplication may be considered as a process or processes that may assign a version (conceptually), including various associated attributes, such as title, artist, tags, etc., to an arrangement. A given song, composition, or piece may have any number of arrangements (e.g., ranging from single digits to thousands or more, including user-generated content).

Other deduplication processes described elsewhere herein may match unmatched arrangements to a composition (e.g., for royalty usage), or may deduplicate arrangements in a context of recommendations or rankings that may be based on machine learning, according to some embodiments. These densification processes, including ML, may be combined and used to devise new technologies expanding the densification coverage further, using audio fingerprinting and other related feature-based densification technologies. To combine and unify these processes, the “piece” object may be regarded as a superset of compositions and unmatched songs, for example.

Clustering may signify identifying the same (or similar) audio backing-track waveforms or files, between different discrete arrangements, and grouping them together to define the formed groups from such process the arrangement groups. Various arrangements of a given song, composition, or piece may include different renderings/versions of the same piece, such as karaoke version versus original recording, piano, acoustic guitar, electronic versions, different speed or tempo, different pitch or musical key, etc. Different versions may be grouped by themselves in separate subgroups under each identified/unidentified piece, in some embodiments, to allow more efficient user-facing usages. The arrangement group may also be a new object, concept, and/or layer between a piece/composition and arrangement in a given ecosystem, for example.

Processes

Certain processes for densification of a content library may include scanning through the content library (arrangement catalog) to densify arrangements into arrangement groups and/or pieces, selecting a canonical arrangement for each arrangement group, filling an arrangement-group table and any other tabular data that may be suitable for ensuing computations. Such processes may be run initially (e.g., on an undensified library or catalog without known pieces or arrangement groups). Collectively, these steps may be referred to as a backfilling process.

The backfilling process, or any of the above processes, may be run for a predetermined period of time or under the condition that systems are below a predetermined threshold of load. Likewise, such processes may be paused or otherwise halted, terminated, aborted, etc., and may be resumed or otherwise run again later, e.g., after a predetermined period of time, a random period of time, or periodically, in some embodiments (hourly, daily, etc.).

Additional specific steps for a backfilling process, in a non-limiting example embodiment, may further include (a) ranking based on popularity, and querying compositions and their associated arrangements; (b) for each queried pieces, doing intra-piece densification (clustering compositions or songs that may correspond to a given piece), and filling arrangement-grouping fields in a database table; and/or (c) processing the unmatched arrangements, ordered by popularity, e.g., after arrangements with matching pieces are densified. If no arrangements remain for densification, these processes may be skipped, but the processes may again be performed at a later time after a predetermined duration and/or upon receiving new content instances in the content library or arrangement catalog, for example.

According to some further embodiments, steps (a) and (b) may be run periodically (e.g., hourly) until all pieces/arrangements in a given library or catalog are densified. For steps (b) and (c), thresholds may be set to prevent grouping of arrangements that exceed a predetermined distance from existing arrangement groups, e.g., to reduce false positives.

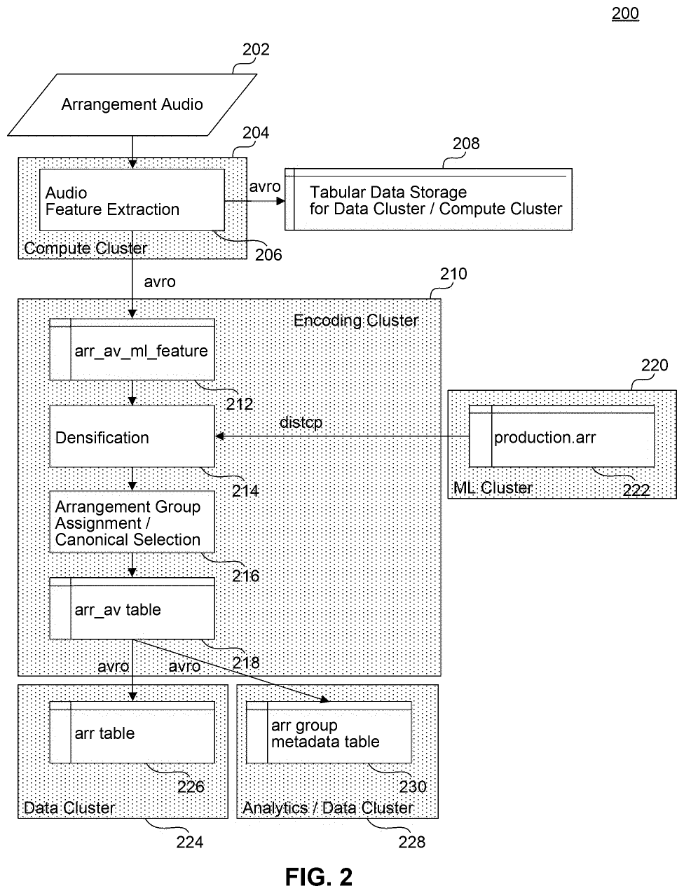

Referring to FIG. 2, as described further below, the arrangement catalog and audio features may be copied regularly (e.g., periodically/daily, occasionally, and/or upon triggering events), from one storage/computing cluster (e.g., ML cluster 220) to the encoding cluster, such as via Apache Hadoop Distributed File System (HDFS) (not shown). This may be done for purposes of identifying whether there may be an existing matched composition to the undensified arrangements. Corresponding metadata may further be used as a basis for choosing a canonical arrangement for a given arrangement group. Additionally, or alternatively, the regular copying process described here may be replaced, in some embodiments, by an Apache Kafka connector sending audio fingerprints directly to one or more clusters for computing, storage, encoding, or any combination thereof.

Densification of new arrangements, e.g., upon upload of user-generated content or otherwise being imported or received by a system, new arrangements may be compared with existing arrangements in a given catalog to find a matching piece or arrangement group, or to assign a new one to it. In some embodiments, this process may be integrated with an ingestion process or with an upload process for user-generated content, so that feedback on grouping suggestions may be delivered in near-real time. Additionally, or alternatively, such processing may run periodically in batches with respect to new content after it is processed in.

Regarding the comparisons, various strategies may be employed. For example, some processes may be configured to compare new arrangements to an entire catalog, or to a subset of the catalog (e.g., canonical arrangements) to allow the processes to run more quickly or with less processing overhead, such as when systems are under relatively high load. Other strategies to streamline comparison processing may include use of hash comparisons (e.g., MinHash) starting with the most popular pieces and terminating with the first match, or otherwise continuing with the rest of the catalog using MinHash LSH, for example, according to some embodiments.

On a longer time horizon (e.g., weekly, monthly, yearly), arrangement groups may be adjusted or revisited for balancing a given content library or arrangement catalog that contains these arrangement groups, in some embodiments. Thus, periodically/monthly, occasionally, and/or upon triggering events, arrangements may be re-clustered under different pieces when a given piece goes over or under a given threshold of density. For example, if a given piece or arrangement group acquires more than a certain number of arrangements, re-running any of the preceding processes, configuring them to rearrange existing clusters, may improve a balance of a catalog or increase a likelihood of an end-user being able to find a specific arrangement other than a canonical arrangement, in some cases.

Additionally, or alternatively, re-running of processes or re-balancing of libraries or catalogs may be performed in response to adoption of better algorithms in the future (e.g., for improved accuracy or computational efficiency), or if arrangement-group sizes within certain ranges may cause performance degradation for existing algorithms of the related densification processes, for example.

Additionally, or alternatively, manual tuning may be allowed, at least by platform administrators or programmers, to improve computational performance or results. In some embodiments, system-internal services may allow manual inspection and/or editing for certain parameters shown in Table 4 below, to list a few non-limiting examples.

TABLE 4

| Process | Input | output |
|---|---|---|
| arrangement | piece | piece, arrangement groups, |
| clustering | | canonical keys |
| arrangement | arrangements | piece, arrangement groups, |
| deduplication | | canonical keys |
| arrangement group | arrangement | piece, arrangement groups, |
| balancing | groups | canonical keys |

Pipeline

FIG. 2 shows a process-flow diagram for a densification pipeline with respect to a given system, such as with various data stores and clusters (e.g., MySQL, RStor, and/or Hadoop) via related processes (e.g., machine learning, business intelligence, distributed copy, etc.). Arrows as depicted correspond to data transmission jobs, which may be performed via various first- or third-party services, in some embodiments of the present disclosure.

Audio Features

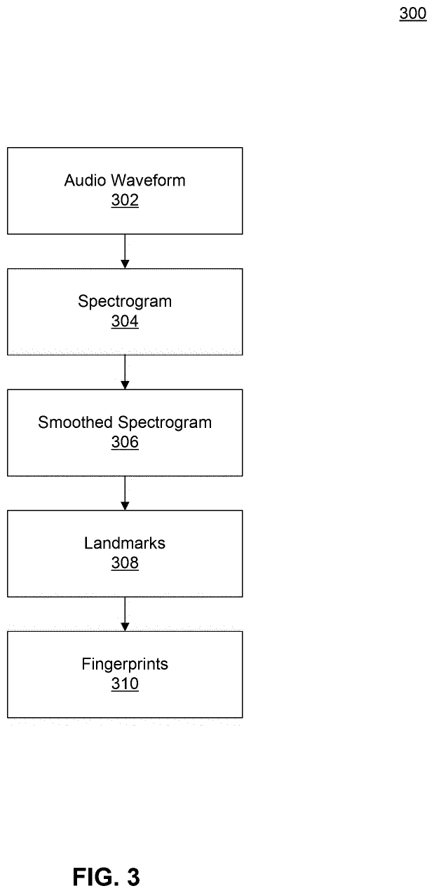

Spectral extrema (e.g., local peaks and/or valleys) may be analyzed and extracted from backing-track audio of an arrangement to serve as a fingerprint of that particular arrangement. Spectral peaks (local maxima) may be suitable for arrangement-group-level densification or deduplication, using signal-processing, e.g., digital signal processing (DSP) algorithms for these purposes, as described further below and with respect to FIGS. 3 and 9-13, for example. Features may also include metadata (e.g., title, artist, album, date, rankings, playback statistics, etc.), such as per the Apache Avro format, according to some embodiments. Sets of features for any given arrangement may be stored, e.g., in databases or database tables, via various data-store mechanisms as described elsewhere herein.

Densification

For clustering or deduplication, both of which may rely on matching fingerprints, as described further elsewhere herein, an algorithm may be used in common between these processes, to calculate similarity indices between pairs of fingerprints, according to some embodiments. For the similarity index, Jaccard similarity may be used, with or without requiring approximation. If Jaccard similarity is used without approximation, inverted-index techniques may be used to scale up performance speed.

For approximating Jaccard similarity, MinHash may be used to derive Jaccard similarity, an example is provided by Hemanth Yamijala, “Counting Unique Items Fast—Better Intersections with MinHash,” Distributed Systems in Practice (Sep. 15, 2015), the entirety of which is incorporated herein by reference for all purposes.

Canonicalization

For a given arrangement group, one arrangement of the arrangement group may be chosen to be the canonical arrangement to be used as a representative arrangement of the arrangement group. This may be prioritized for search results in user-facing scenarios following densification, according to some embodiments.

In some embodiments, canonical arrangements may be chosen in descending order of a series of criteria or accompanying tie-breakers. For instance, an algorithm may analyze metadata and determine whether or not arrangements are third-party arrangements, and evaluate Wilson scores of upvotes in proportion to downvotes, to name a few non-limiting examples. Additionally, or alternatively, user interactions, social signals, or crowd-sourcing, etc., may also factor into canonicalization processes.

Language Detection

Arrangements having duplicate backing tracks but different languages for lyrics, or different lyrics for the same song (regardless of language), may be classified in the same arrangement group if no measures are taken for language detection. In some use cases, such as according to preferences of end-users or platform administrators, arrangement groups in a given catalog may be configured to target specific languages, excluding others. An automated process to match an arrangement's lyrics and to a specific language may be further combined with densification, in some embodiments.

Possible solutions may include referencing an ML arrangement cluster, because lyrics may already be separated for ML processing with respect to language groups. Additionally, or alternatively, a dedicated language-detection algorithm or system may also be used. As another measure for search results, language filters may also be applied to select one or more languages for desired results.

Backing Track Similarity Detection

Arrangement catalogs with duplication may include hundreds of versions of a given composition, for example. Some amount of duplication may be detected by text metadata (e.g., title, artist) alone, in some cases. However, users may enter incorrect information for certain arrangements, or a given artist may be unclear with a collaboration, for instance, or in some cases, maintaining alternate versions can be desirable, e.g. acoustic as opposed to fully orchestrated, to name a few non-limiting examples. By using audio features, similarity may be automatically detectable between different arrangements, and such detected information may inform future actions accordingly.

Being able to determine duplication and similarity may have multiple applications. For example, the enhanced technology of this disclosure may be used for improving quality of search results and recommendations. In some embodiments, if there is a search query in the form of a string, for example, “Let It Go,” a user submitting such a query may want to filter all exact duplicates, but also may want to leave in variations such as acoustic guitar, piano, orchestral, etc.

Techniques for Determining Similarity

One way to determine similarity of two audio signals, in some embodiments, may include extracting fingerprints in order to compare and/or align the separate audio signals. A fingerprint may be generated via a set of landmarks in audio waveforms, spectrograms, or derivatives thereof. For example, landmarks may correspond to local extrema for certain frequency ranges of selected samples. More specifically, in some embodiments, local peaks may be determined for certain audio features, such as via spectral analysis (spectral peaks).

Comparing the similarity of the two fingerprints may be done using techniques including but not limited to MinHash and/or LSH, to calculate Jaccard similarity with computational efficiency. The hashes used for similarity may be persisted in a data store, such that the benefit of one hash calculation may be leveraged across multiple similarity determinations or comparisons. An implementation may involve a given hash being compared against other hashes to find duplicates, scaling in linear time (an 0(n) computation). Computational efficiency may be improved by using an index that may be used for hash-bucketing similar items using LSH, with any of various suitable hashing algorithms such as MinHash, according to some embodiments.

Experiments

An example of an iteration (arr_20_30_en) for a given arrangement catalog is shown in Table 5 below. This represents the top four English-language compositions ordered by decayed record counts having 20 and 30 arrangements.

TABLE 5

| | | | Arrangement | min/median/max N. for | |
|---|---|---|---|---|---|
| Composition | Title - Artist | Arrangements | Groups | Arrangement Groups | Labels |
| c_3685759 | Trampoline - | 29 | 4 | 1/2/7 | c_3685759_arr_labeled |
| | SHAED | | | | |
| c_5441936 | Treat me like | 30 | 10 | 1/4.5/19 | c_5441936_arr_labeled |
| | somebody - Tink | | | | |
| c_1667658 | Kemesraan - | 20 | 9 | 1/2/7 | c_1667658_arr_labeled |
| | Iwan Fals | | | | |
| c_4707401 | Old town road | 30 | 14 | 1/1/9 | c_4707401_arr_labeled |
| | remix | | | | |

Spectral-Peak Algorithm Parameter Search

To perform audio fingerprinting algorithms based on spectral peaks, a catalog set may be selected from the dataset by choosing a most recorded (decayed count) arrangement from each arrangement group as canonical arrangements. The rest of the data set thus may be used as a query set.

For a given arrangement in the query set, another arrangement from the catalogue that has the highest similarity to the query may be returned as the next match. Such a match may be regarded as correct in both the composition and arrangement group level.

According to some embodiments, a grid search of hyperparameters (e.g., hyperopt or similar) function may be used to search for a set of parameters achieving performance that exceeds other parameters with respect to the ‘arr_20_30_en’ set. An example configuration of such parameters is shown in Table 6 below.

TABLE 6

```
parameter_space = {
  ‘permutation’: hp.choice(‘permutation’, [32, 64, 128, 256,
512]),
  ‘sample_rate’: hp.choice(‘sample_rate’, [5000, 8000, 11025,
22050, 44100]),
  ‘offset’: hp.quniform(‘offset’, 0, 10, 1),
  ‘duration’: hp.quniform(‘duration’, 5, 30, 5),
  ‘normalize’: hp.quniform(‘normalize’, 0, 1, 1),
  ‘fft_size’: hp.choice(‘fft_size’, [512, 1024, 2048]),
  ‘hop_ratio’: hp.choice(‘hop_ratio’, [0.125, 0.25, 0.5]),
  ‘maxima_filter_size’: hp.choice(‘maxima_filter_size’, [5,
11, 23, 47]),
  ‘fan_value’: hp.choice(‘fan_value’, [3, 5, 11, 23])
}
```

Various metrics may be measured, including match rate of arrangement groups and compositions, and area under a curve (AUC) of arrangement groups and compositions, for example. The AUCs may be obtained from matched/unmatched histogram of similarities. For some parameter-search algorithms, a goal may be to maximize arrangement match rate.

According to an embodiment, Table 7 lists example results of the parameter search (top ten), ordered by AUC of arrangement groups then AUC of compositions.

TABLE 7

| permutation | sample_rate | offset | duration | normalize | fft_size | hop_ratio | maxima_filter_size | fan_value |
|---|---|---|---|---|---|---|---|---|
| 512 | 22050 | 5.0 | 25.0 | 1 | 512 | 0.500 | 23 | 23 |
| 512 | 22050 | 8.0 | 25.0 | 1 | 512 | 0.250 | 23 | 23 |
| 512 | 22050 | 3.0 | 30.0 | 0 | 512 | 0.125 | 47 | 11 |
| 512 | 22050 | 8.0 | 30.0 | 0 | 512 | 0.500 | 47 | 11 |
| 512 | 22050 | 7.0 | 30.0 | 0 | 512 | 0.500 | 47 | 11 |
| 512 | 22050 | 5.0 | 30.0 | 0 | 512 | 0.125 | 47 | 11 |
| 512 | 22050 | 4.0 | 25.0 | 0 | 512 | 0.125 | 47 | 11 |
| 512 | 22050 | 9.0 | 25.0 | 0 | 512 | 0.500 | 47 | 11 |
| 512 | 22050 | 9.0 | 20.0 | 0 | 512 | 0.500 | 47 | 11 |
| 512 | 22050 | 6.0 | 30.0 | 0 | 512 | 0.500 | 47 | 3 |

| arr_group_auc | arr_group_matched_rate | composition_auc | composition_matched_rate |
|---|---|---|---|
| 0.997449 | 0.958333 | 0.695626 | 1.0 |
| 0.997449 | 0.958333 | 0.695626 | 1.0 |
| 0.997289 | 0.902778 | 0.635658 | 1.0 |
| 0.997289 | 0.902778 | 0.635658 | 1.0 |
| 0.997289 | 0.902778 | 0.635658 | 1.0 |
| 0.997289 | 0.902778 | 0.635658 | 1.0 |
| 0.996847 | 0.944444 | 0.626398 | 1.0 |
| 0.996847 | 0.944444 | 0.626398 | 1.0 |
| 0.996785 | 0.944444 | 0.628198 | 1.0 |
| 0.996726 | 0.930556 | 0.638282 | 1.0 |

Parameters Ordered by Metrics

From these results, such as shown in Table 7 above, parameters may be adjusted as shown in Table 8 below, to continue to a subsequent process.

TABLE 8

```
{
  ‘permutation’: 512,
  ‘sample_rate’: 22050,
  ‘offset’: 5,
  ‘duration’: 25,
  ‘normalize’: 1,
  ‘fft_size’: 512,
  ‘hop_ratio’: 0.5,
  ‘maxima_filter_size’: 23,
  ‘fan_value’: 23
}
```

Given this set of parameters, histograms and receiving operator characteristic (ROC) curves for the chosen parameters are depicted here as well.

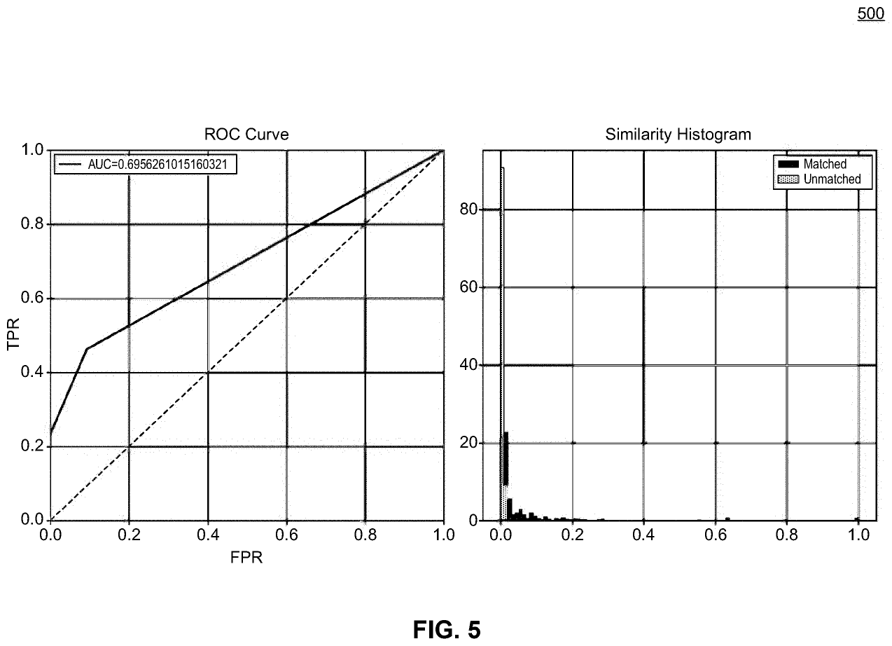

FIG. 5 illustrates a similarity histogram and receiver operating characteristic (ROC) curve corresponding to an example composition, according to some embodiments.

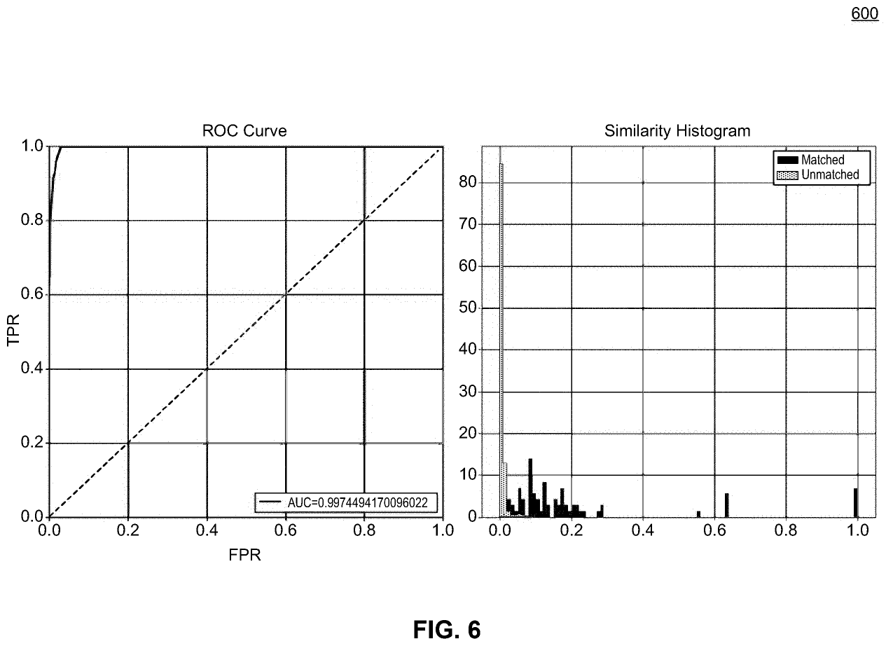

FIG. 6 illustrates a similarity histogram and ROC curve corresponding to an example arrangement group, according to some embodiments.

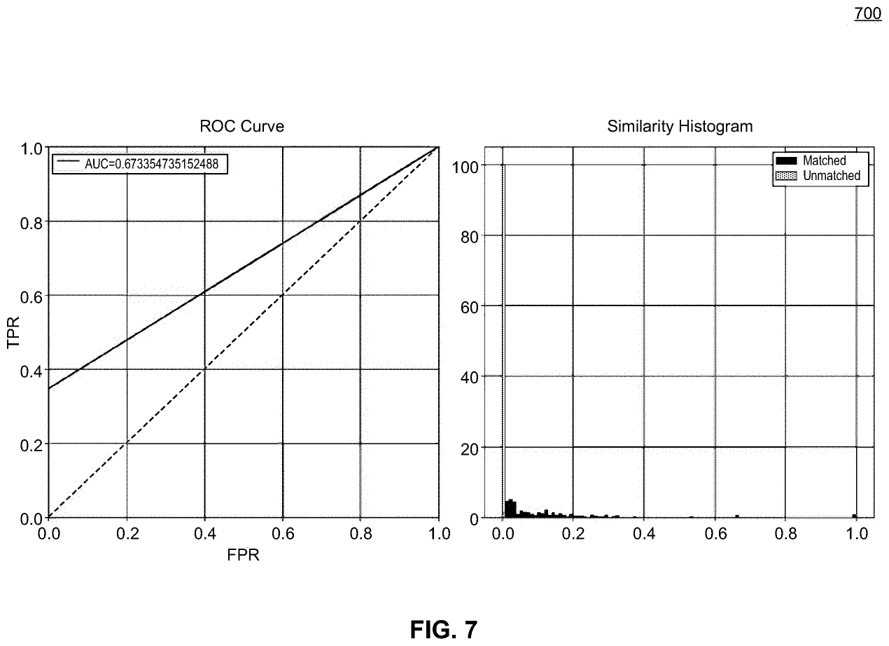

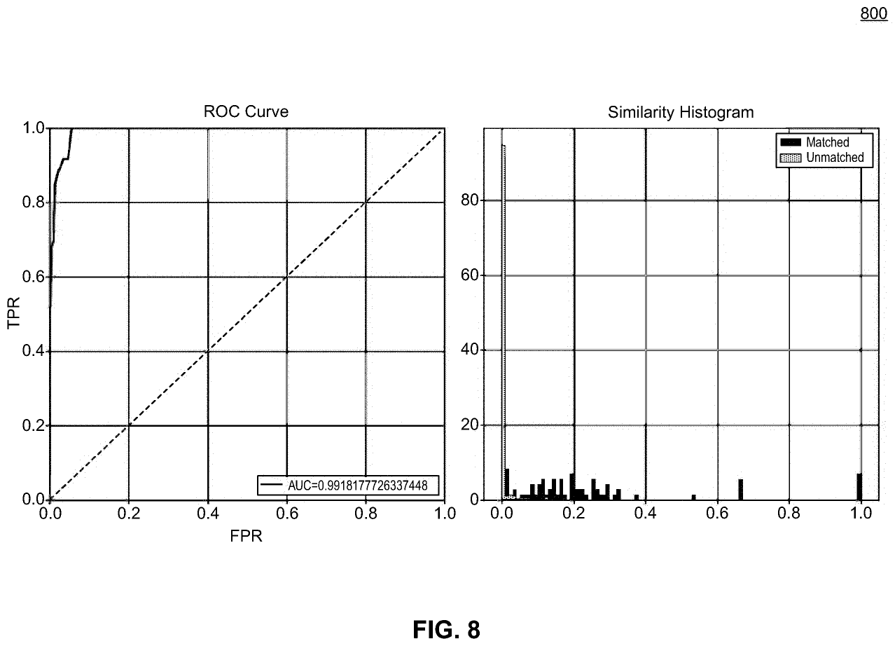

Another iteration of these parameters is shown below in Table 9, along with resulting histograms and ROC curves in subsequent figures (FIGS. 7 and 8).

TABLE 9

```
{
  ‘permutation’: 512,
  ‘sample_rate’: 11025,
  ‘offset’: 3.0,
  ‘duration’: 10,
  ‘normalize’: 1.0,
  ‘fft_size’: 1024,
  ‘hop_ratio’: 0.125,
  ‘maxima_filter_size’: 23,
  ‘fan_value’: 3
}
```

FIG. 7 illustrates a similarity histogram and ROC curve corresponding to an example composition having an alternative parameter set, according to some embodiments.

FIG. 8 illustrates a similarity histogram and ROC curve corresponding to an example arrangement group having the alternative parameter set, according to some embodiments.

Usage

A goal of the enhanced techniques described herein is to include a search functionality that may accept one or more arrangement keys and return similar arrangements in response, and to do so in a performant way. Performing hashing for each input performance key at query-time, per some use cases, may not be sufficiently performant or efficient, for example.

By contrast, precomputing audio features on backing tracks and storing them in a persistent data store, in accordance with arrangement feature (metadata) extraction as described elsewhere herein, may further streamline the overall processes to make this usage goal more reasonable to achieve, by way of a streamlined hash lookup rather than massive computation across an entire library or catalog of content. However, to perform the necessary calculations in a meaningful way, assistance of machine learning may also be leveraged to improve computational performance and quality of results.

Scaling and Persistence

Initial seeding may be performed with respect to a subset of a library or catalog, corresponding to a predetermined number of the most popular arrangements therein. For instance, there may be 150,000 arrangements with ten or more user-performance starts or attempts over the last 30 days, in an embodiment. Seeding may also be performed in less time by way of parallel processing.

The densification may involve any of several different algorithms for each of clustering and deduplication. If a catalog does not include arrangement groups initially, the arrangement groups for the catalog may be built from scratch. The building of the arrangement groups for the catalog thus may involve performing the clustering algorithm(s), according to some embodiments.

Audio Fingerprint Extraction

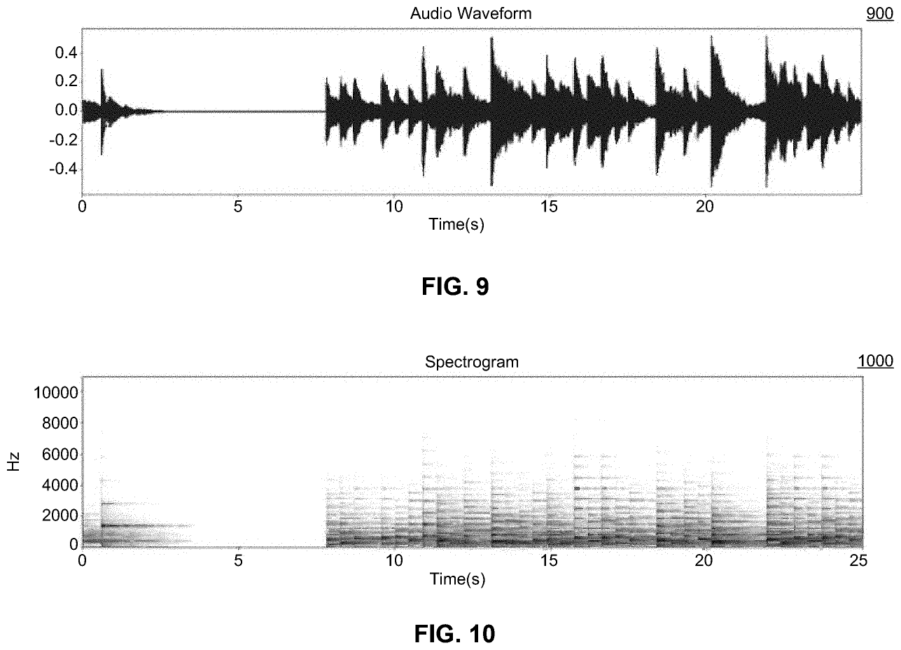

FIG. 3 illustrates a flowchart for an example method of generating audio fingerprints, according to some embodiments. FIG. 3 may be considered as a diagram of one example fingerprinting extraction process. Each of the five steps (302, 304, 306, 308, and 310) shown in FIG. 3 may be considered with respect to each of FIGS. 9-13, respectively.

FIG. 9 illustrates an example audio waveform, according to some embodiments.

An audio waveform of a content instance may be read, from which a backing track corresponding to an arrangement may be derived. In some embodiments, other preprocessing may be performed, such as monaural conversion, resampling, requantization, or normalization (e.g., volume, amplitude, etc.). Additionally, or alternatively, certain offsets may be determined, and certain parts of the waveform before, after, or between offsets may be included in or omitted from further processing.

FIG. 10 illustrates an example audio spectrogram corresponding to the waveform of FIG. 9, according to some embodiments. Referring to FIGS. 10-13, some embodiments may include performing feature extraction based on numerical values computed at any one of these stages depicted, for example.

The fingerprint algorithm may spectrally analyze (equivalent to deriving a spectrogram from) an audio file. As shown in FIG. 10, the first 25 seconds of audio are sampled from a given content instance, depicting a spectrogram.

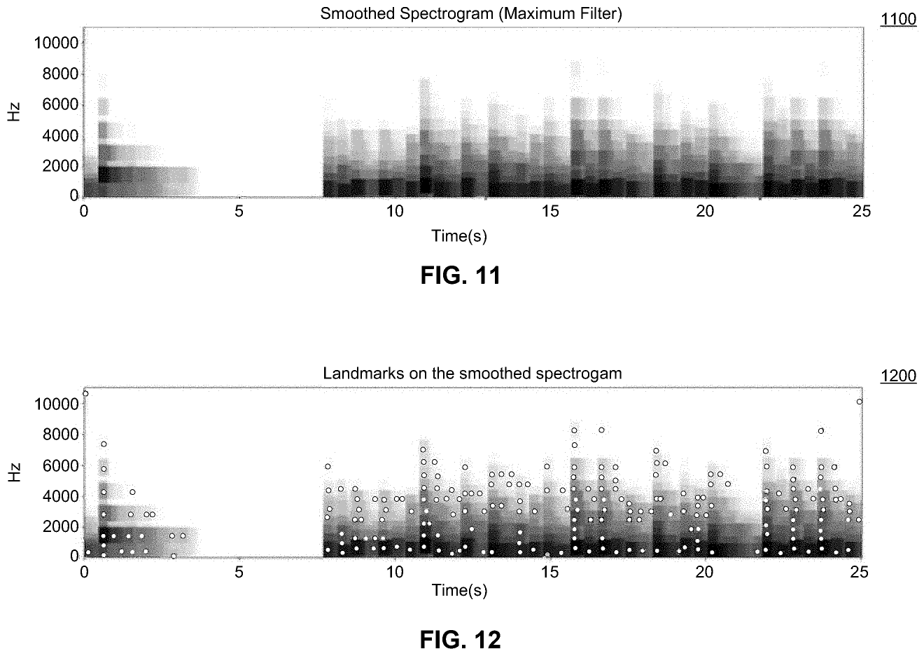

FIG. 11 illustrates the spectrogram of FIG. 10, smoothed using an example filter, according to some embodiments.

After spectral analysis, as per FIG. 10, a filter may be applied on the analyzed spectrum to locate local extrema (e.g., local minima or maxima per predetermined frequency ranges on an individual audio sample). Filter parameters may be varied for any number of iterations. Such filtering may facilitate accurate matching, even in cases where noise may be introduced such as by rerecording or lossy audio compression, for example.

FIG. 12 illustrates the smoothed spectrogram of FIG. 11, highlighting examples of designated landmarks, according to some embodiments.

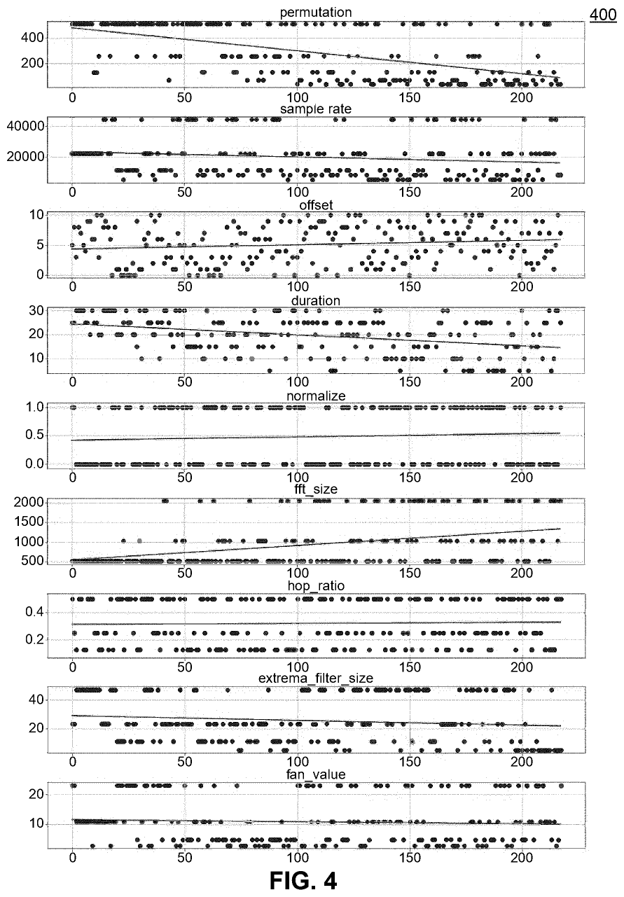

The local extrema may then be used to derive landmarks for audio fingerprints. The landmarks are shown as dots in FIG. 12. In this example, the landmarks correspond to local maxima, as derived by a maxima filter for set frequency ranges (see also FIG. 4), repeated across multiple samples within the range of samples selected, in this case, the first 25 seconds of audio for a selected content instance. Other values (length, offset, sampling rate) may be selected for other use cases.

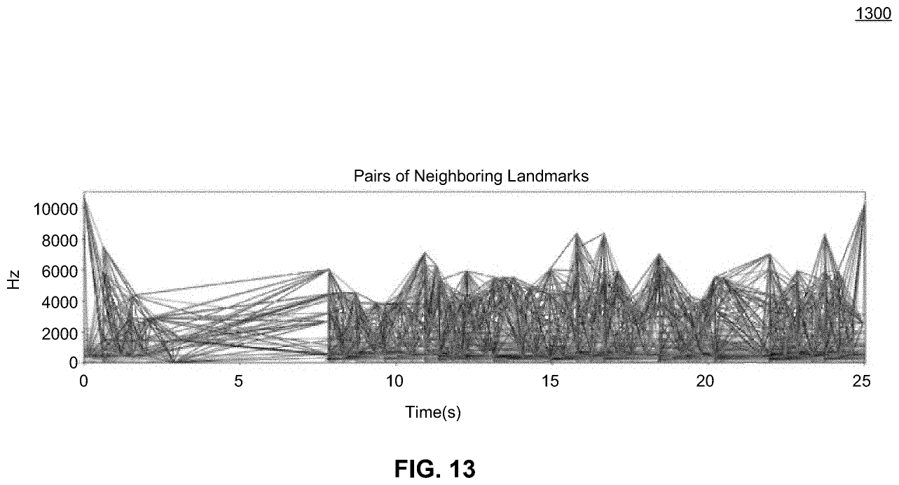

FIG. 13 illustrates an example values as related in data structures corresponding to tuples used an example audio fingerprint derivation, according to some embodiments.

After the landmarks are located, neighboring landmarks may be connected (related), as shown using lines in FIG. 13, defined by tuples including starting landmark frequency and endpoints, and their time differences in sample frames, for example. Tuples may then be converted to effectively unique hash values according to a hashing algorithm. A collection of the hash values from the tuples (lines) may then be used as an audio fingerprint of the given 25-second window of audio selected for this example.

In an embodiment, to convert an example tuple defining the line between two neighboring landmarks, the tuple (freq_1, freq_2, time_1, time_2) may be encoded as freq_1*(2\hat{ }(FRAME BITS+FREQ BITS))+freq_2*(2\hat{ }FRAME BITS)+abs(t2−t1), where FRAME BITS and FREQ BITS represent the range of frequency and time in bits.

Matching Algorithm

A matching algorithm may be given a query (input) arrangement to compare against a catalog of arrangements, or given a set of ungrouped arrangements to be grouped. Comparison of certain hashes or fingerprints may be a translation-invariant process, matching audio sequences independently of their respective positions within a given audio recording, for instance. Multiple matching hashes or fingerprints with nearby or adjacent offsets (temporal locality) may indicate a stronger match for a given set of recordings, for example. Jaccard similarity may be used to determine whether two arrangements may be grouped together, according to a predetermined threshold, in some embodiments. To calculate the Jaccard similarity, an “inverted index” technique may be used, as with related querying or search technologies described elsewhere herein.

Arrangement Densification by Lyrics

Arrangements, particularly songs that have lyrics, may be further densified in arrangement groups by their lyrics, where lyrics may be identical or may overlap to various extents. For example, following densification (clustering and/or canonicalization) of the arrangements by audio, quality of the arrangement groups may be further improved by refining them (splitting them into smaller groups) by looking at lyrics that may be similar or different across arrangements, such as in a given arrangement group.

An implementation of arrangement densification by lyrics may involve lyrics densification. Lyrics may originate from any variety of sources, including various third-party databases for query and retrieval, websites for direct access or scraping, metadata provided with a recording, karaoke track, subtitle file, or user-generated content on a given platform, such as social media, streaming, or other type of content-sharing platform. Additionally, or alternatively, lyrics may be extracted from audio recordings by ML models and corresponding processes or algorithms for speech recognition (Gaussian mixture emissions, hidden Markov models, other speech-to-text engines, etc.) For purposes of demonstrating lyrics tokenization, an original sample of lyrics is reproduced in relevant part as the string shown below:
‘MALAM TERAKHIR Upload By:: BELIND4 00 (P) Malam ini . . . ’

In this specific example, where a given character may be one of multiple equivalent or allographic representations of a single grapheme in common (e.g., where upper- and lower-case letters are equivalent), such allographs may be reduced to a single representation of the grapheme in common. In this example, alphabetical representations of lyrics may be converted to be the same case, e.g., all miniscule or majuscule, to allow for case-insensitive tokenization. In this example, the lyrics are shown as having been converted to all lower-case letters in the following string:
‘malam terakhir upload by:: belind4 00 (p) malam ini . . . ’

Extraneous characters unnecessary for lyrics tokenization (e.g., punctuation, emoji, other symbols) may be removed, leaving relevant characters with respect to the language of the lyrics. In this example, alpha-numeric characters remain, as shown here:
‘malam terakhir upload by belind4 00 p malam ini’

In a further operation for lyrics tokenization, the string may be split at word boundaries, as shown in the tuple below:
[‘malam’, ‘terakhir’, ‘upload’, ‘by’, ‘belind4’, ‘00’, ‘p’, ‘malam’, ‘ini’]

Such a tuple of split words may be treated in similar fashion as the audio hashes for the audio densification described elsewhere herein. The split words may be used to calculate Jaccard similarities between lyrics by looking at sets of words from arrangement lyrics. Unlike the case for densification by audio that may start with arrangements that match compositions before arrangements that do not match other compositions, clustering by lyrics may start by processing arrangement groups already formed via audio densification, meaning that audio may take precedence over lyrics.

Further processing arrangement groups into smaller groups may increase the number of canonical arrangements, potentially increasing cases in which arrangements may appear to be “duplicates” of each other. However, this may be a tradeoff in use cases of densification and retrieval such as with karaoke or social music, for example. For these uses, such distinctions may be regarded as beneficial when separating arrangements where that differ by lyrics to any extent.

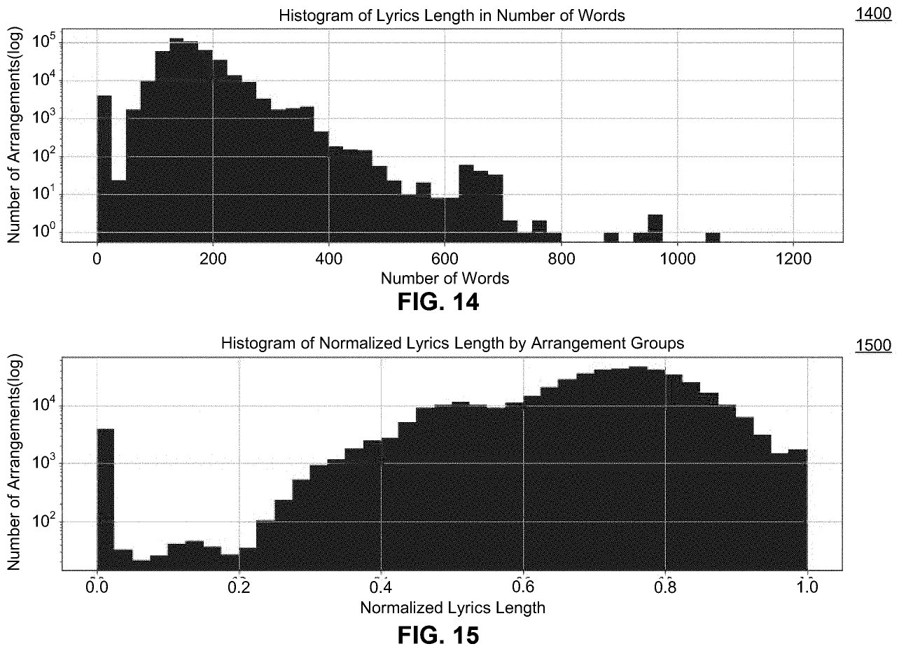

FIG. 14 shows a histogram of lyrics length in number of words, according to some embodiments.

FIG. 15 shows a histogram of normalized lyrics length by arrangement groups, according to some embodiments.

By looking at the two histograms of FIGS. 14 and 15, relatively shorter lyrics may be defined, for purposes of this example, as having the lyrics length less than fifty words and being shorter than 20% of the length of the longest lyrics in the same arrangement group, as determined by audio densification. The histograms in FIGS. 14 and 15 as shown are from a sample of one thousand arrangement groups ordered by number of arrangements within each arrangement group. Normalized length may be obtained by dividing the number of words of an arrangement by the largest number of words from the lyrics within its arrangement group.

Example Method

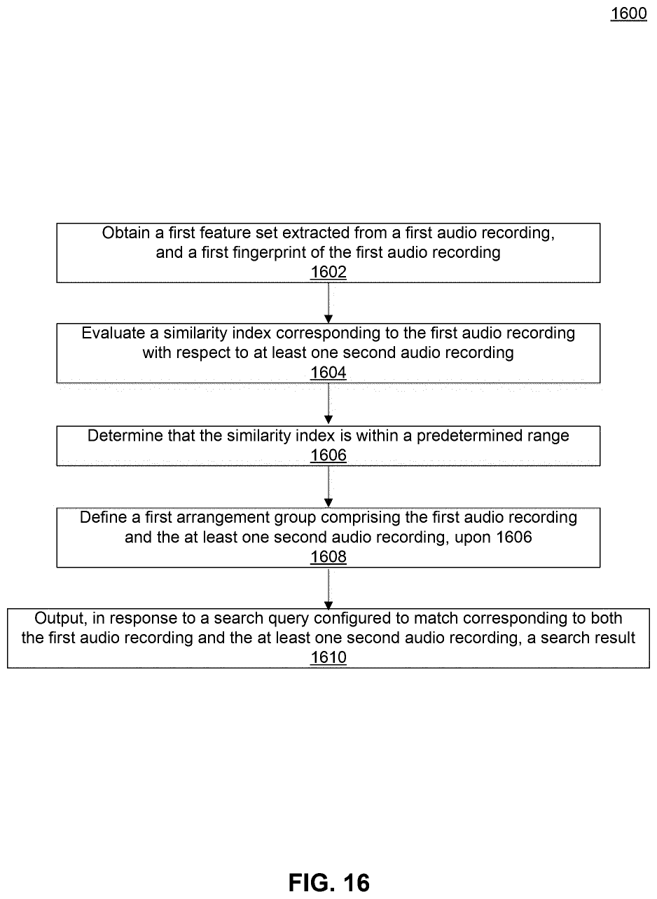

FIG. 16 is a flowchart illustrating a method 1600 for operation of the enhanced database platform integration techniques described herein, according to some embodiments. Method 1600 may be performed by processing logic that may comprise hardware (e.g., circuitry, dedicated logic, programmable logic, microcode, etc.), software (e.g., instructions executing on a processing device), or a combination thereof. Not all steps of method 1600 may be needed in all cases to perform the enhanced techniques disclosed herein. Further, some steps of method 1600 may be performed simultaneously, or in a different order from that shown in FIG. 16, as will be understood by a person of ordinary skill in the art.

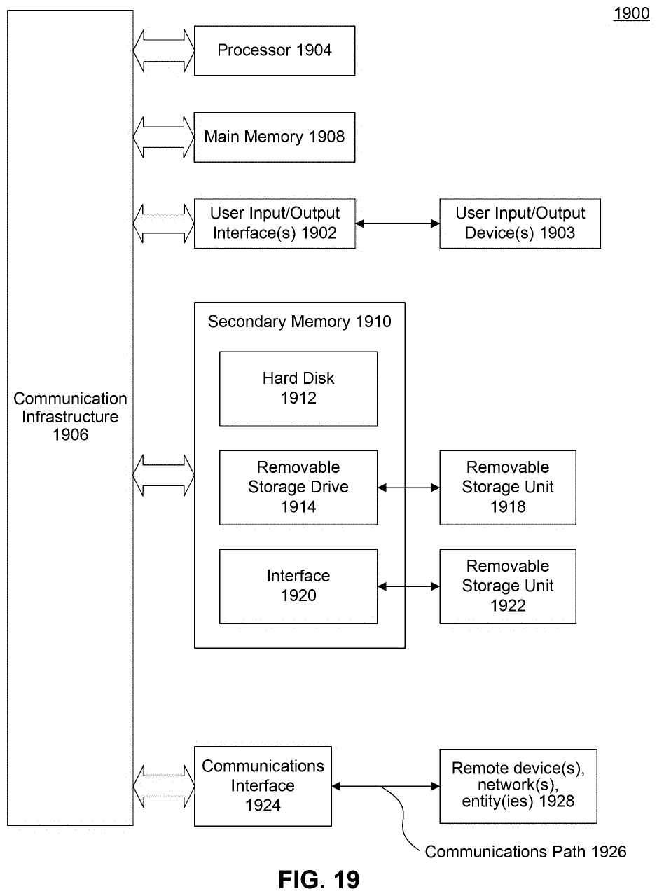

Method 1600 shall be described with reference to FIGS. 16-19. However, method 1600 is not limited only to those example embodiments. The steps of method 1600 may be performed by at least one computer processor coupled to at least one memory device. An example processor and memory device(s) are described below with respect to FIG. 19. In some embodiments, method 1600 may be performed by components of systems shown in FIGS. 2, 17, 18, or any combination thereof, which may further include at least one processor and memory such as those of FIG. 19.

In 1602, memory 1908-1922 and at least one processor 1904 may be configured to obtain, by the at least one computer processor, a first feature set extracted from a first audio recording, and a first fingerprint of the first audio recording. In different use cases, different media types or content instances may be processed, e.g., video, animations, images, etc. Fingerprints may be derived as explained elsewhere herein, such as with respect to FIGS. 3 and 9-13, for example. In some embodiments, at least one fingerprint corresponding to a given audio recording may be derived from a given feature set extracted from the given audio recording.

Any such feature set, fingerprint, or a combination thereof, may be extracted on the fly from any given audio recording upon intake or ingestion into a given collection or music library, for example. Additionally, or alternatively, the same or similar feature set, fingerprint, or combination thereof, may be stored in a given database, data lake, data warehouse, or other equivalent data store, in some embodiments, for later retrieval based on any of various selection criteria.

The first feature set, in some embodiments, may include vectorized attributes of a first content instance. Such attributes may include metadata corresponding to a given content instance. Thus, the first feature set may include metadata corresponding to the first content instance. Such metadata may include multiple structural elements, in some embodiments. Further, at least one structural element may correspond to at least part of the first metadata. Examples of metadata may include, but are not limited to, content length (playback time), segment break(s), indications of recording types associated with particular segments (e.g., where at least one user may record a vocal solo, duet, chorus, etc., within a given segment), such as for user-generated content.

In some embodiments, metadata may be represented by tags, such as may be represented by fields in a markup language, such as the Standard Generalized Markup Language (SGML; ISO 8879:1986). Other examples of markup languages are described further below, and may be used additionally or alternatively to existing tagging solutions. Other tagging means may include database structures, including structured or unstructured data stores, in plain text or binary data formats, including key-value pair data stores, hash tables, relational databases, or any combination thereof. Further examples of some databases are described further below.

Additionally, or alternatively, vectorized attributes of a feature set may include one or more values derived from a quantification or analysis of a given content instance (e.g., spectral analysis of an audio recording, color analysis of an image or video, etc.), and/or at least one result of any statistical processing thereof. For example, features may include values of sound intensity (amplitude) within a given audio frequency range, or multiple frequency ranges, at a given time as sampled. Further values of intensity/amplitude for at least some of the same frequency ranges may be repeated for different time samples of a given content instance.

Such values may be formatted in a way suitable for representation as a spectrogram or sonograph, for example, but actual visual representation is not necessary for feature extraction in some embodiments. These values may be vectorized according to various dimensions of spectral analysis. A sample of intensity values at predetermined frequency ranges may be handled, stored, or otherwise represented as a tuple, vector, list, etc., and may be repeated for multiple samples, within a separate matrix, tensor, table, etc., to name a few non-limiting examples.

Samples may correspond to specific predetermined time-based segments (absolute or relative) of a given content instance. For instance, samples may be grouped and further analyzed, such as corresponding to the first five seconds of a content instance, the next two seconds (e.g., between specific timestamps or relative positions from a given pointer), the middle quintile, the last ten percent, or the like, according to some embodiments. Moreover, content segments or other structural elements may be compared, matched, classified, and/or evaluated across different content instances, for example, as may inform a similarity index as evaluated per 1604 described further below.

Additionally, or alternatively, in some embodiments, analysis of video features may include a tuple, vector, matrix, or at least one further parameter indicating a degree to which a first parameter is applied (e.g., numeric scale of luminous intensity, blurring, residual trailing, RGB values, correlation of video features with audio features such as sound frequencies, etc.), which may be related to or suggestive of certain other aspects of a given content instance (e.g., whether or not the content is user-generated, first-party, or from a partner artist). Analysis of images or video features may be helpful for certain multimedia content (e.g., karaoke or music videos), but such further analysis may be omitted for purposes of densification or duplication based on music or audio content in a context of MIR.

In 1604, processor 1904 may be configured to evaluate, using at least one first machine-learning algorithm, a similarity index corresponding to the first audio recording with respect to at least one second audio recording. ML-based evaluation may be based at least in part on the first feature set extracted from the first audio recording, and a second feature set extracted from the at least one second audio recording; the first fingerprint of the first audio recording, and at least one second fingerprint of the at least one second audio recording; or a combination thereof, according to some embodiments.

As noted above, fingerprints may be derived as explained elsewhere herein, such as with respect to FIGS. 3 and 9-13, for example. As further noted herein, fingerprints may be based on at least part of the feature extraction of 1602, such as landmark values or statistical local extrema within specified frequency ranges derived from spectral analysis of an audio recording, for example.

Algorithms for the evaluation of 1604 may include machine-based classification, clustering, and/or machine-learning processes useful for densification or deduplication. Such algorithms may include fuzzy matching (approximate string matching) and its extensions to non-string domains such as audio, tokens, fingerprints, graph-based clustering and tree-based clustering or extensions thereof for grouping/deduplicating, etc. Additionally with these algorithms, or alternatively, MinHash algorithms may be used, such as for similarity estimations, to name a few non-limiting examples.

The similarity index may be calculated, among other possible ways, from various transforms, comparisons, weighted averaging, etc., of features from the feature sets corresponding to any two or more content instances. In some embodiments, content segments or other structural elements may be compared, matched, classified, and/or evaluated across different content instances, for example.

Even if different instances of content are not an exact match (e.g., arrangement-level duplication), there may be certain content segments of a first content instance that match or resemble other content segments present in the second content instance. Such segments may be transposed in time position, tempo, key, etc., which may occur, for example, by sampling, user-generated content, shared backing tracks, shared lyrics, etc.

A similarity index may increase based on a number (absolute or relative) of like features across multiple content instances. Like features may include features that are identical (equal or otherwise equivalent) in some respects, or that may be within a given range set as sufficient to establish similarity for a given value, feature, or preponderance of values or features. At least one similarity index may be applied to content instances, collectively, to each as a whole, to specific content segments (absolute or relative within each content instance), or to any combination thereof.

In some embodiments, a similarity index may be calculated by deterministic logic, algebraic and/or relational operators, statistical analysis, or other such operations. Additionally, or alternatively, evaluation of any given similarity index may be enabled, facilitated, and/or enhanced by ML processing as described elsewhere herein.

In 1606, processor 1904 may be configured to determine that the similarity index is within a predetermined range. The predetermined range may be a configurable or tunable value set within a tolerance of what may be considered similar, to balance how loose or tight densification clusters or arrangement groups may be, depending on available data sets (e.g., content libraries), preferences of a user or end-user, system parameters, or other considerations on the part of the user, end-user, administrator, programmer, partner, or other relevant third party, for example.

The determination of 1606 may be made using any logical or relational operator(s), for example, with respect to any endpoint or other value within the predetermined range. Other conditional operators may also be applied, depending on other parameters of interest. Additionally, or alternatively, machine-learning or other algorithms that may be the same as, equivalent to, or similar to those of the evaluation of 1604 may further factor into, facilitate, or otherwise enhance the determination of 1606, according to some embodiments.

In 1608, processor 1904 may be configured to define, a first arrangement group comprising the first audio recording and the at least one second audio recording, upon the determination of 1606. To define a given arrangement group, any of various techniques such as those described herein may be used for purposes of 1608.

For example, the first audio recording may have been determined at 1606 to be similar to a known arrangement that is part of a known arrangement group. In this case, the first audio recording may be associated with or assigned to the known arrangement group as defining the first arrangement group. In another case, in which no previous arrangement groups are known for the first audio recording and the at least one second audio recording, an arrangement group may be created or initialized as including at least the first audio recording and the at least one second audio recording.

Together, or separately, other definitions, classifications, categorizations, or subdivisions of a given arrangement group may be made after or upon creation of the given arrangement group. Further examples, such as canonicalization, genre recognition, etc., may be included, and are described in further detail elsewhere herein.

In 1610, processor 1904 may be configured to output, by the at least one computer processor, in response to a search query configured to match corresponding to both the first audio recording and the at least one second audio recording, a search result corresponding to one of the first arrangement group, the first audio recording, or the at least one second audio recording, instead of the first audio recording and the at least one second audio recording.

In other words, in a search where a search query matches both the first audio recording and the at least one second audio recording, a conventional result of the search may return both the first audio recording and the at least one second audio recording as top matches by relevance. However, assuming that these audio recordings belong to the same arrangement group, based at least on the determination of 1606 and/or the definition of 1608, the search result(s) may not contain all matching content instances that pertain to a given arrangement group.

Rather, a search result may contain a reduced sample, in some embodiments, or even just one, of the arrangements in a given arrangement group. This reduction of similar hits for a given query thereby densifies the search results. Specific looseness or tightness of the arrangement groups, and thereby densification, may be adjusted, configured, tuned, or otherwise changed, at least based on user preferences, makeup of the target data set (e.g., content library), or a combination thereof, for example.

Any content library or content instance, may be accessed by or processed using at least one instance of processor 1904 at a server of a service provider or content-distribution network (CDN), in some embodiments. Additionally, or alternatively, any processing, such as included with any feature extraction or fingerprinting, may run on any same, equivalent, or similar instance of processor 1904, at a client or end-user device (e.g., consumer handheld terminal device such as smartphone, tablet, or phablet; wearable device such as a smart watch or smart visor; laptop or desktop computer; set-top box or similar streaming device; etc.). Client-side transforming, including any content playback and/or rendering, may be included with presentation of any search results, such as for a canonical arrangement or any other representative arrangement for a returned piece or densified cluster, for example.

In addition to any feature extraction or fingerprinting, server-side or client-side transforming may include statically or dynamically encoding, recoding, transcoding, and/or decoding audio, video, and/or text content via any of multiple audio/video codecs. The audio, video, and/or text content may be encoded, recoded, transcoded, or decoded before, during, or after any transforming in 1608. For example, any of the encoding, recoding, transcoding, and/or decoding may be performed by any processor 1904 as mentioned above. Any recognition of lyrics or other particular features may also be performed at the server side, client side, or a combination of both, according to some embodiments.

Example Media Devices

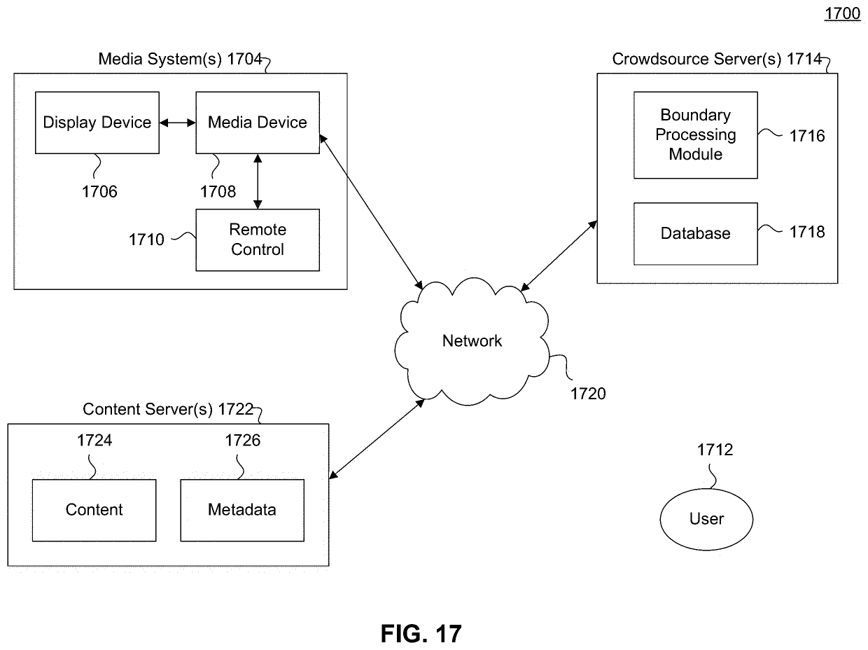

FIG. 17 illustrates a block diagram of a multimedia environment 1700, according to some embodiments. In non-limiting examples, multimedia environment 1700 may directed to streaming media, user-generated content/promotions, or a combination thereof.

The multimedia environment 1700 may include one or more media systems 1704, one or more content servers 1722, and one or more crowdsource servers 1714, communicatively coupled via a network 1720. In various embodiments, the network 1720 can include, without limitation, wired and/or wireless intranet, extranet, Internet, cellular, Bluetooth and/or any other short range, long range, local, regional, global communications network, as well as any combination thereof.

Media system 1704 may include a display device 1706, media device 1708 and remote control 1710. Display device 1706 may be a monitor, television, computer, smartphone, tablet, and/or projector, to name just a few examples. Media device 1708 may be a streaming media device, DVD device, audio/video playback device, cable box, and/or digital video recording device, to name just a few examples. In some embodiments, the media device 1708 can be a part of, integrated with, operatively coupled to, and/or connected to display device 1706. The media device 1708 may be configured to communicate with network 1720.

A user 1712 may interact with media system 1704 via remote control 1710. Remote control 1710 can be any component, part, apparatus or method for controlling media device 1708 and/or display device 1706, such as a remote control, a tablet, laptop computer, tablet computer, smartphone, on-screen controls, integrated control buttons, or any combination thereof, to name just a few examples.

Content servers 1722 (also called content sources 1722) may each include databases to store content 1724 and metadata 1726. Content 1724 may include any combination of music, videos, karaoke, multimedia, images, still pictures, text, graphics, gaming applications, advertisements, software, and/or any other content or data objects in electronic form. In some embodiments, metadata 1726 may comprise data about content 1724. For example, metadata 1726 may include associated or ancillary information indicating or related to composer, artist, album, tracks, lyrics, history, year, alternate versions, related content, applications, and/or any other information pertaining or relating to the content 1724. Metadata 1726 may also or alternatively include links to any such information pertaining or relating to the content 1724. Metadata 1726 may also or alternatively include at least one index of content 1724.

Crowdsource servers 1714 may each include a boundary processing module 1716 and a database 1718. In some embodiments, boundary processing module 1716 receives and processes information identifying portions in content 1724 having little or no interest to users. In some crowd-sourced embodiments, boundary processing module 1716 receives such information from users 1712 via their media systems 1704. Boundary processing module 1716 may store such received information.

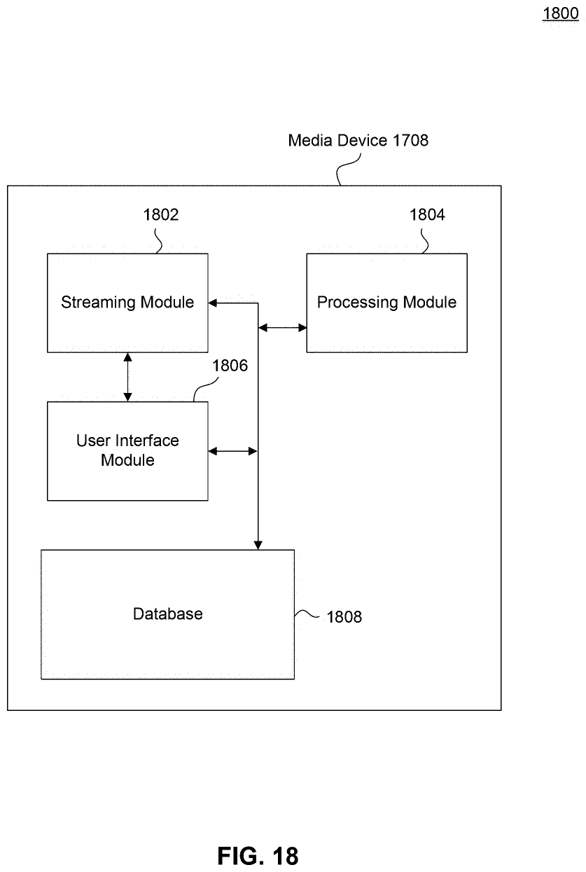

FIG. 18 illustrates an example block diagram of the media device 1708, according to some embodiments. Media device 1708 may include a streaming module 1802, processing module 1804, user interface module 1806 and database 1808.

Referring to FIGS. 17 and 18 together, in some embodiments, user 1712 may use remote control 1710 to interact with the user interface module 1806 of media device 1708 to select content, such as an audio recording, music video, karaoke backing track and/or accompaniment, etc. The streaming module 1802 of media device 1708 may request the selected content from content server(s) 1722 over the network 1720. Content server(s) 1722 may transmit the requested content to the streaming module 1802. Media device 1708 may transmit the received content to display device 1706 for presentation to user 1712. In streaming embodiments, the streaming module 1802 may transmit the content to display device 1706 in real time or near real time as it receives such content from content server(s) 1722. In non-streaming embodiments, media device 1708 may buffer or store the content received from content server(s) 1722 in database 1808 for later playback on display device 1706.

Example Computer System

Various embodiments and/or components therein can be implemented, for example, using one or more computer systems, such as computer system 1900 shown in FIG. 19. Computer system 1900 can be any computer or computing device capable of performing the functions described herein. For example, one or more computer systems 1900 can be used to implement any embodiments of FIGS. 1-19, and/or any combination or sub-combination thereof.

The following example computer system, or multiple instances thereof, may be used to implement methods 300 or 1600 of FIGS. 3 and 16, respectively, systems as shown in FIGS. 2, 17, 18, or any component thereof, according to some embodiments.

Various embodiments may be implemented, for example, using one or more well-known computer systems, such as computer system 1900 shown in FIG. 19. One or more computer systems 1900 may be used, for example, to implement any of the embodiments discussed herein, as well as combinations and sub-combinations thereof.

Computer system 1900 may include one or more processors (also called central processing units, or CPUs), such as a processor 1904. Processor 1904 may be connected to a bus or communication infrastructure 1906.

Computer system 1900 may also include user input/output device(s) 1905, such as monitors, keyboards, pointing devices, etc., which may communicate with communication infrastructure 1906 through user input/output interface(s) 1902.

One or more of processors 1904 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, vector processing, array processing, etc., as well as cryptography, including brute-force cracking, generating cryptographic hashes or hash sequences, solving partial hash-inversion problems, and/or producing results of other proof-of-work computations for some blockchain-based applications, for example. With capabilities of general-purpose computing on graphics processing units (GPGPU), the GPU may be particularly useful in at least the feature-extraction and machine-learning aspects described herein.

Additionally, one or more of processors 1904 may include a coprocessor or other implementation of logic for accelerating cryptographic calculations or other specialized mathematical functions, including hardware-accelerated cryptographic coprocessors. Such accelerated processors may further include instruction set(s) for acceleration using coprocessors and/or other logic to facilitate such acceleration.

Computer system 1900 may also include a main or primary memory 1908, such as random access memory (RAM). Main memory 1908 may include one or more levels of cache. Main memory 1908 may have stored therein control logic (i.e., computer software) and/or data.

Computer system 1900 may also include one or more secondary storage devices or secondary memory 1910. Secondary memory 1910 may include, for example, a main storage drive 1912 and/or a removable storage device or drive 1914. Main storage drive 1912 may be a hard disk drive or solid-state drive, for example. Removable storage drive 1914 may be a floppy disk drive, a magnetic tape drive, a compact disk drive, an optical storage device, tape backup device, and/or any other storage device/drive.

Removable storage drive 1914 may interact with a removable storage unit 1918. Removable storage unit 1918 may include a computer usable or readable storage device having stored thereon computer software (control logic) and/or data. Removable storage unit 1918 may be a floppy disk, magnetic tape, compact disk, DVD, optical storage disk, and/any other computer data storage device. Removable storage drive 1914 may read from and/or write to removable storage unit 1918.

Secondary memory 1910 may include other means, devices, components, instrumentalities or other approaches for allowing computer programs and/or other instructions and/or data to be accessed by computer system 1900. Such means, devices, components, instrumentalities or other approaches may include, for example, a removable storage unit 1922 and an interface 1920. Examples of the removable storage unit 1922 and the interface 1920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1900 may further include a communication or network interface 1924. Communication interface 1924 may enable computer system 1900 to communicate and interact with any combination of external devices, external networks, external entities, etc. (individually and collectively referenced by reference number 1928). For example, communication interface 1924 may allow computer system 1900 to communicate with external or remote devices 1928 over communication path 1926, which may be wired and/or wireless (or a combination thereof), and which may include any combination of LANs, WANs, the Internet, etc. Control logic and/or data may be transmitted to and from computer system 1900 via communication path 1926.

Computer system 1900 may also be any of a personal digital assistant (PDA), desktop workstation, laptop or notebook computer, netbook, tablet, smart phone, smart watch or other wearable, appliance, part of the Internet of Things (IoT), and/or embedded system, to name a few non-limiting examples, or any combination thereof.

Computer system 1900 may be a client or server, accessing or hosting any applications and/or data through any delivery paradigm, including but not limited to remote or distributed cloud computing solutions; local or on-premises software (e.g., “on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), database as a service (DBaaS), etc.); and/or a hybrid model including any combination of the foregoing examples or other services or delivery paradigms.

Any applicable data structures, file formats, and schemas may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

Any pertinent data, files, and/or databases may be stored, retrieved, accessed, and/or transmitted in human-readable formats such as numeric, textual, graphic, or multimedia formats, further including various types of markup language, among other possible formats. Alternatively or in combination with the above formats, the data, files, and/or databases may be stored, retrieved, accessed, and/or transmitted in binary, encoded, compressed, and/or encrypted formats, or any other machine-readable formats.

Interfacing or interconnection among various systems and layers may employ any number of mechanisms, such as any number of protocols, programmatic frameworks, floorplans, or application programming interfaces (API), including but not limited to Document Object Model (DOM), Discovery Service (DS), NSUserDefaults, Web Services Description Language (WSDL), Message Exchange Pattern (MEP), Web Distributed Data Exchange (WDDX), Web Hypertext Application Technology Working Group (WHATWG) HTML5 Web Messaging, Representational State Transfer (REST or RESTful web services), Extensible User Interface Protocol (XUP), Simple Object Access Protocol (SOAP), XML Schema Definition (XSD), XML Remote Procedure Call (XML-RPC), or any other mechanisms, open or proprietary, that may achieve similar functionality and results.

Such interfacing or interconnection may also make use of uniform resource identifiers (URI), which may further include uniform resource locators (URL) or uniform resource names (URN). Other forms of uniform and/or unique identifiers, locators, or names may be used, either exclusively or in combination with forms such as those set forth above.

Any of the above protocols or APIs may interface with or be implemented in any programming language, procedural, functional, or object-oriented, and may be compiled or interpreted. Non-limiting examples include C, C++, C#, Objective-C, Java, Swift, Go, Ruby, Perl, Python, JavaScript, WebAssembly, or virtually any other language, with any other libraries or schemas, in any kind of framework, runtime environment, virtual machine, interpreter, stack, engine, or similar mechanism, including but not limited to Node.js, V8, Knockout, jQuery, Dojo, Dijit, OpenUI5, AngularJS, Express.js, Backbonejs, Ember.js, DHTMLX, Vue, React, Electron, and so on, among many other non-limiting examples.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1900, main memory 1908, secondary memory 1910, and removable storage units 1918 and 1922, as well as tangible articles of manufacture embodying any combination of the foregoing. Such control logic, when executed by one or more data processing devices (such as computer system 1900), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 19. In particular, embodiments may operate with software, hardware, and/or operating system implementations other than those described herein.

### CONCLUSION

It is to be appreciated that the Detailed Description section, and not any other section, is intended to be used to interpret the claims. Other sections may set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries may be defined as long as the specified functions and relationships (or equivalents thereof) are appropriately performed. Also, alternative embodiments may perform functional blocks, steps, operations, methods, etc. using orderings different from those described herein.

References herein to “one embodiment,” “an embodiment,” “an example embodiment,” “some embodiments,” or similar phrases, indicate that the embodiment described may include a particular feature, structure, or characteristic, but every embodiment may not necessarily include the particular feature, structure, or characteristic. Moreover, such phrases are not necessarily referring to the same embodiment.

Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method of signal processing, comprising:
obtaining, by at least one computer processor, a first feature set extracted from a first audio recording, and a first fingerprint of the first audio recording;
evaluating, by the at least one computer processor, using at least one first machine-learning algorithm, a similarity index corresponding to the first audio recording with respect to at least one second audio recording, based at least in part on:
the first feature set extracted from the first audio recording, and a second feature set extracted from the at least one second audio recording;
the first fingerprint of the first audio recording, and at least one second fingerprint of the at least one second audio recording; or
a combination thereof;
defining, by the at least one computer processor, a first arrangement group comprising the first audio recording and the at least one second audio recording, upon determining, by the at least one computer processor, that the similarity index is within a predetermined range; and
outputting, by the at least one computer processor, in response to a search query configured to match corresponding to both the first audio recording and the at least one second audio recording, a search result corresponding to one of the first arrangement group, the first audio recording, or the at least one second audio recording, instead of the first audio recording and the at least one second audio recording.

2. The computer-implemented method of claim 1, further comprising:
analyzing, by the at least one computer processor, a frequency spectrum of the audio recording for each of a plurality of time values of at least part of a time duration of the first audio recording;
calculating, by the at least one computer processor, at least one local extreme value in a frequency domain for each of the plurality of time values of the at least part of the time duration of the first audio recording;
selecting, by the at least one computer processor, for each of the plurality of time values, a first frequency value corresponding to a first local extreme value;
populating, by the at least one computer processor, for the at least part of the time duration of the first audio recording, a first tuple comprising the first frequency value for each of the plurality of time values; and
computing, by the at least one computer processor, a first hash value of the first tuple.

3. The computer-implemented method of claim 2, further comprising:
selecting, by the at least one computer processor, for each of the plurality of time values, a subsequent frequency value corresponding to a subsequent local extreme value;
populating, by the at least one computer processor, for the at least part of the time duration of the first audio recording, a subsequent tuple comprising the subsequent frequency value for each of the plurality of time values; and
computing, by the at least one computer processor, a subsequent hash value of the subsequent tuple.

4. The computer-implemented method of claim 3, wherein the first fingerprint is generated based at least in part on the first hash value and at least one instance of the subsequent hash value.

5. The computer-implemented method of claim 1, wherein the first feature set is based at least in part on frequency-spectral peaks in a time domain of the first audio recording.

6. The computer-implemented method of claim 1, wherein the search result comprises a canonical arrangement representing the first arrangement group.

7. The computer-implemented method of claim 6, further comprising assigning, by the at least one computer processor, a priority value to the canonical arrangement relative to other audio recordings that correspond to non-canonical arrangements.

8. The computer-implemented method of claim 1, wherein the determining that the similarity index is within the predetermined range indicates, within a predetermined confidence interval, that the first audio recording and the at least one second audio recording were created using a same backing track or using different backing tracks having a predetermined degree of similarity.

9. The computer-implemented method of claim 1, further comprising:
detecting, by the at least one computer processor, using at least one second machine-learning algorithm, the first fingerprint, or a combination thereof, a first set of lyrics corresponding to the first audio recording;
detecting, by the at least one computer processor, using the at least one second machine-learning algorithm, the at least one second fingerprint, or a combination thereof, at least one second set of lyrics corresponding to the at least one second audio recording; and
defining, by the at least one computer processor, at least one second arrangement group corresponding to the at least one second set of lyrics.

10. The computer-implemented method of claim 9, further comprising redefining, by the at least one computer processor, the first arrangement group to exclude audio recordings corresponding to lyrics different from the first set of lyrics.

11. The computer-implemented method of claim 9, wherein the first set of lyrics corresponds to a first language, and wherein the at least one second set of lyrics corresponds to at least one second language.

12. The computer-implemented method of claim 11, wherein the first language corresponds to the first arrangement group, and wherein a given second language of the at least one second language corresponds to a second arrangement group.

13. The computer-implemented method of claim 1, further comprising:
identifying, by the at least one computer processor, the first audio recording based at least in part on the first fingerprint;
referencing, by the at least one computer processor, a data store corresponding to the first audio recording; and
wherein the obtaining comprises retrieving, by the at least one computer processor, the first feature set from the data store corresponding to the first audio recording, wherein the first feature set has been previously extracted from the first audio recording and stored in the data store corresponding to the first audio recording.

14. A non-transitory computer-readable storage medium comprising instructions stored thereon that, when executed by at least one computer processor, cause the at least one computer processor to perform operations comprising:
obtaining a first feature set extracted from a first audio recording, and a first fingerprint of the first audio recording;
evaluating, using at least one first machine-learning algorithm, a similarity index corresponding to the first audio recording with respect to at least one second audio recording, based at least in part on:
the first feature set extracted from the first audio recording, and a second feature set extracted from the at least one second audio recording;
the first fingerprint of the first audio recording, and at least one second fingerprint of the at least one second audio recording; or
a combination thereof;
defining a first arrangement group comprising the first audio recording and the at least one second audio recording, upon determining that the similarity index is within a predetermined range; and
outputting, in response to a search query configured to match corresponding to both the first audio recording and the at least one second audio recording, a search result corresponding to one of the first arrangement group, the first audio recording, or the at least one second audio recording, instead of the first audio recording and the at least one second audio recording.

15. The non-transitory computer-readable storage medium of claim 14, the operations further comprising:
analyzing a frequency spectrum of the audio recording for each of a plurality of time values of at least part of a time duration of the first audio recording;
calculating at least one local extreme value in a frequency domain for each of the plurality of time values of the at least part of the time duration of the first audio recording;
selecting, for each of the plurality of time values, a first frequency value corresponding to a first local extreme value;
populating, for the at least part of the time duration of the first audio recording, a first tuple comprising the first frequency value for each of the plurality of time values; and
computing a first hash value of the first tuple.

16. The non-transitory computer-readable storage medium of claim 15, the operations further comprising:
selecting, for each of the plurality of time values, a subsequent frequency value corresponding to a subsequent local extreme value;
populating, for the at least part of the time duration of the first audio recording, a subsequent tuple comprising the subsequent frequency value for each of the plurality of time values; and
computing a subsequent hash value of the subsequent tuple.

17. The non-transitory computer-readable storage medium of claim 16, wherein the first fingerprint is generated based at least in part on the first hash value and at least one instance of the subsequent hash value.

18. The non-transitory computer-readable storage medium of claim 14, wherein the first feature set is based at least in part on frequency-spectral peaks in a time domain of the first audio recording.

19. The non-transitory computer-readable storage medium of claim 14, wherein the search result comprises a canonical arrangement representing the first arrangement group.

20. The non-transitory computer-readable storage medium of claim 19, the operations further comprising assigning a priority value to the canonical arrangement relative to other audio recordings that correspond to non-canonical arrangements.

21. The non-transitory computer-readable storage medium of claim 14, wherein the determining that the similarity index is within the predetermined range indicates, within a predetermined confidence interval, that the first audio recording and the at least one second audio recording were created using a same backing track or using different backing tracks having a predetermined degree of similarity.

22. The non-transitory computer-readable storage medium of claim 21, the operations further comprising:
detecting, using at least one second machine-learning algorithm, the first fingerprint, or a combination thereof, a first set of lyrics corresponding to the first audio recording;
detecting, using the at least one second machine-learning algorithm, the at least one second fingerprint, or a combination thereof, at least one second set of lyrics corresponding to the at least one second audio recording; and
defining at least one second arrangement group corresponding to the at least one second set of lyrics.

23. The non-transitory computer-readable storage medium of claim 22, the operations further comprising redefining the first arrangement group to exclude audio recordings corresponding to lyrics different from the first set of lyrics.

24. The non-transitory computer-readable storage medium of claim 22, wherein the first set of lyrics corresponds to a first language, and wherein the at least one second set of lyrics corresponds to at least one second language.

25. The non-transitory computer-readable storage medium of claim 24, wherein the first language corresponds to the first arrangement group, and wherein a given second language of the at least one second language corresponds to a second arrangement group.

26. The non-transitory computer-readable storage medium of claim 14, the operations further comprising:
identifying, by the at least one computer processor, the first audio recording based at least in part on the first fingerprint;
referencing, by the at least one computer processor, a data store corresponding to the first audio recording; and
wherein the obtaining comprises retrieving, by the at least one computer processor, the first feature set from the data store corresponding to the first audio recording, wherein the first feature set has been previously extracted from the first audio recording and stored in the data store corresponding to the first audio recording.

27. A system, comprising memory and at least one computer processor configured to perform operations comprising:
obtaining a first feature set extracted from a first audio recording, and a first fingerprint of the first audio recording;
evaluating, using at least one first machine-learning algorithm, a similarity index corresponding to the first audio recording with respect to at least one second audio recording, based at least in part on:
the first feature set extracted from the first audio recording, and a second feature set extracted from the at least one second audio recording;
the first fingerprint of the first audio recording, and at least one second fingerprint of the at least one second audio recording; or
a combination thereof;
defining a first arrangement group comprising the first audio recording and the at least one second audio recording, upon determining that the similarity index is within a predetermined range; and
outputting, in response to a search query configured to match corresponding to both the first audio recording and the at least one second audio recording, a search result corresponding to one of the first arrangement group, the first audio recording, or the at least one second audio recording, instead of the first audio recording and the at least one second audio recording.

28. The system of claim 27, the operations further comprising:
analyzing a frequency spectrum of the audio recording for each of a plurality of time values of at least part of a time duration of the first audio recording;
calculating at least one local extreme value in a frequency domain for each of the plurality of time values of the at least part of the time duration of the first audio recording;
selecting, for each of the plurality of time values, a first frequency value corresponding to a first local extreme value;
populating, for the at least part of the time duration of the first audio recording, a first tuple comprising the first frequency value for each of the plurality of time values; and
computing a first hash value of the first tuple.

29. The system of claim 28, the operations further comprising:
selecting, for each of the plurality of time values, a subsequent frequency value corresponding to a subsequent local extreme value;
populating, for the at least part of the time duration of the first audio recording, a subsequent tuple comprising the subsequent frequency value for each of the plurality of time values; and
computing a subsequent hash value of the subsequent tuple.

30. The non-transitory computer-readable storage medium of claim 29, wherein the first fingerprint is generated based at least in part on the first hash value and at least one instance of the subsequent hash value.

31. The system of claim 27, wherein the first feature set is based at least in part on frequency-spectral peaks in a time domain of the first audio recording.

32. The system of claim 27, wherein the search result comprises a canonical arrangement representing the first arrangement group.

33. The non-transitory computer-readable storage medium of claim 32, the operations further comprising assigning a priority value to the canonical arrangement relative to other audio recordings that correspond to non-canonical arrangements.

34. The system of claim 27, wherein the determining that the similarity index is within the predetermined range indicates, within a predetermined confidence interval, that the first audio recording and the at least one second audio recording were created using a same backing track or using different backing tracks having a predetermined degree of similarity.

35. The non-transitory computer-readable storage medium of claim 34, the operations further comprising:
detecting, using at least one second machine-learning algorithm, the first fingerprint, or a combination thereof, a first set of lyrics corresponding to the first audio recording;
detecting, using the at least one second machine-learning algorithm, the at least one second fingerprint, or a combination thereof, at least one second set of lyrics corresponding to the at least one second audio recording; and
defining at least one second arrangement group corresponding to the at least one second set of lyrics.

36. The non-transitory computer-readable storage medium of claim 35, the operations further comprising redefining the first arrangement group to exclude audio recordings corresponding to lyrics different from the first set of lyrics.

37. The non-transitory computer-readable storage medium of claim 35, wherein the first set of lyrics corresponds to a first language, and wherein the at least one second set of lyrics corresponds to at least one second language.

38. The non-transitory computer-readable storage medium of claim 37, wherein the first language corresponds to the first arrangement group, and wherein a given second language of the at least one second language corresponds to a second arrangement group.

39. The system of claim 27, the operations further comprising:
identifying, by the at least one computer processor, the first audio recording based at least in part on the first fingerprint;
referencing, by the at least one computer processor, a data store corresponding to the first audio recording; and
wherein the obtaining comprises retrieving, by the at least one computer processor, the first feature set from the data store corresponding to the first audio recording, wherein the first feature set has been previously extracted from the first audio recording and stored in the data store corresponding to the first audio recording.
